(19) United States
(12) Patent Application Publication
(10) Pub. No.: US 2003/0158755 A1
(43) Pub. Date: Aug. 21, 2003

(54) System and method for conducting drug use evaluation

(76) Inventor: Sherry L. Neuman, Galt, CA (US)

Correspondence Address: Louis M Heidelberger, Reed Smith LLP, 2500 One Liberty Place, Philadelphia, PA, 19103-7301, US

(21) Appl. No.: 09/795,135

(22) Filed: Mar. 1, 2001

(51) Int. Cl. G06F 17/60

(52) U.S. Cl. 705/3

(57) ABSTRACT

A system and method for conducting drug use evaluation for a patient prior to the patient's appointment with a prescriber. The drug use evaluation is conducted for the patient based on a list of drugs that the prescriber may prescribe at the upcoming appointment with the patient.

### BACKGROUND OF THE INVENTION

1. Field of the Invention

The present invention relates to prescriptions, and, more particularly, to systems and methods for conducting drug use evaluation before a prescriber selects a drug for a patient's prescription.

2. Description of the Related Art

When a patient is in need of medical treatment, a doctor, a nurse, an assistant, a computer, or other entity will diagnose the patient. In many instances, the recommended treatment for the diagnosis requires that the patient take one or more drugs. For many conditions or diseases, it is necessary that a prescriber create a prescription for the patient to obtain the drug needed to treat the diagnosed condition. The prescribed drug may be an over-the-counter drug, i.e., a drug that may be sold without federal or state prescription requirements, or a drug that can only be sold by a pharmacy or dispensed after an order by an appropriately licensed prescriber. The prescriber may be a doctor, an assistant, or other individual licensed to prescribe drugs.

In some instances, the prescriber will prescribe a drug to a patient that may be in conflict with other medications the patient is taking or other diseases or conditions that are present for that patient. For example, a patient being treated with warfarin to prevent blood clots may be prescribed a new drug by another specialist to treat arthritis. If taken together, the patient could experience internal bleeding. This complication is generally referred to as a drug-drug interaction because the two drugs interact to produce an adverse result. Besides drug-drug interactions, there are a number of other complications that may result from taking a prescribed medication, such as drug-disease contraindications, drug-allergy contraindications drug-age contraindications, drug-gender contraindications, etc. To prevent such complications, it is common for pharmacies, claims processors, and pharmacy benefit managers to perform drug use evaluation, a process designed to promote appropriate and effective use of drugs by warning pharmacists and prescribers that potentially harmful events may occur if a specific drug is dispensed as prescribed.

In a typical scenario, a prescriber provides a patient with a prescription for a drug, and the patient later brings the prescription to be filled by the pharmacist. The pharmacist enters the prescription into the pharmacist's computer database and performs drug use evaluation to determine if any potential complications exist. If the pharmacist discovers a potential complication, the pharmacist typically telephones the prescriber to notify the prescriber of the drug use evaluation alert. In many instances, in addition to the pharmacy's determination that a drug use evaluation alert exists, claims processors or pharmacy benefit managers, perform drug use evaluation to determine if any conflicts exist along with whether the patient's health insurance provider will pay for all or some of the cost of the prescribed drug. On occasion, the claims processor's drug use evaluation or the pharmacy benefit management company's drug use evaluation might reveal a potential complication that was not discovered by the pharrnacist's drug use evaluation system. For example, the patient may have received prescriptions from another pharmacy so these prescriptions will not be of record in the pharmacist's database, but is of record in the claims processor's database or the pharmacy benefit management company's database. Hence, the pharmacist's drug use evaluation might not reveal, for example, a potential drug-drug interaction between two drugs filled at different pharmacies. The claims processor or pharmacy benefit management company will advise the pharmacist of the drug use evaluation alert, who then notifies the prescriber of the drug use evaluation alert.

Technology now exists to assist prescribers to perform drug use evaluation prior to prescribing a drug for a patient. These processes allow prescribers to identify and resolve potential problems before prescriptions are presented to the pharmacist to fill. In order to perform comprehensive drug use evaluation before prescribing a drug, the prescriber first diagnoses the patient and chooses a specific drug for a prescription. The patient's prescription history, which is typically stored in a pharmacy's database, a pharmacy benefit manager's database, or claims processor's database is then accessed to perform the drug use evaluation for the specific drug. The drug use evaluation is then performed for the chosen drug and the prescriber is notified of any potential complications revealed by the drug use evaluation before prescribing the drug to the patient. Unfortunately, many prescribers do not utilize prospective drug use evaluation at the point-of-patient care because it takes too long to establish a real time connection with the databases that store the patient's prescription history during a typical patient-prescriber encounter.

### SUMMARY OF THE INVENTION

Generally speaking, embodiments of the present invention strive to provide a system and method by which a prescriber can review the results of a drug use evaluation at the point-of-care before prescribing a drug to a patient.

Other objects, advantages and features associated with the present invention will become more readily apparent to those skilled in the art from the following detailed description. As will be realized, the invention is capable of other and different embodiments, and its several details are capable of modification in various obvious aspects, all without departing from the invention. Accordingly, the drawings and the description are to be regarded as illustrative in nature, and not limitative.

### BRIEF DESCRIPTION OF THE DRAWINGS

FIG. 1 is a schematic of a system according to one embodiment of the present invention.

FIG. 2 illustrates a flow diagram illustrating one embodiment of a method according to the present invention.

FIG. 3 illustrates a flow diagram of drug use evaluation conducted in accordance with one embodiment of the present invention.

FIG. 4 illustrates a flow diagram of a drug-pregnancy precaution assessment conducted during drug use evaluation in accordance with one embodiment of the present invention.

FIG. 5 illustrates a flow diagram of a drug-disease contraindication assessment conducted during drug use evaluation in accordance with one embodiment of the present invention.

FIG. 6 illustrates a flow diagram of a drug-alcohol precaution assessment conducted during drug use evaluation in accordance with one embodiment of the present invention.

FIG. 7 illustrates a flow diagram of a therapeutic duplication assessment conducted during drug use evaluation in accordance with one embodiment of the present invention.

FIG. 8 illustrates a flow diagram of a drug-drug interaction assessment conducted during drug use evaluation in accordance with one embodiment of the present invention.

FIG. 9 illustrates a flow diagram of an early/late refill assessment conducted during drug use evaluation in accordance with one embodiment of the present invention.

FIG. 10 illustrates a flow diagram of a high dose assessment conducted during drug use evaluation in accordance with one embodiment of the present invention.

FIG. 11 is an example of a patient list display produced on an electronic prescription creation device of the system illustrated in FIG. 1.

FIG. 12 is an example of a drug selection quick list display produced on the electronic prescription creation device of the system illustrated in FIG. 1.

FIG. 13 is an example of a therapeutic category drug selection display produced on the electronic prescription creation device of the system illustrated in FIG. 1.

FIG. 14 is an example of a subcategory drug selection display produced on the electronic prescription creation device of the system illustrated in FIG. 1.

FIG. 15 is an example of a formulary and non-formulary subcategory display produced on the electronic prescription creation device of the system illustrated in FIG. 1.

FIG. 16 is an example of an alphabetic drug selection display produced on the electronic prescription creation device of the system illustrated in FIG. 1.

FIG. 17 is an example of a strength and formulation selection display produced on the electronic prescription creation device of the system illustrated in FIG. 1

FIG. 18 is an example of a prescription creation display produced on the electronic prescription creation device of the system illustrated in FIG. 1.

FIG. 19 is an example of a drug evaluation alert display produced on the electronic prescription creation device of the system illustrated in FIG. 1.

FIG. 20 is an example of a finish prescription display produced on the electronic prescription creation device of the system illustrated in FIG. 1.

FIG. 21 is an example of a paper prescription produced with the electronic prescription creation device of the system illustrated in FIG. 1.

### DETAILED DESCRIPTION OF THE PREFERRED EMBODIMENTS

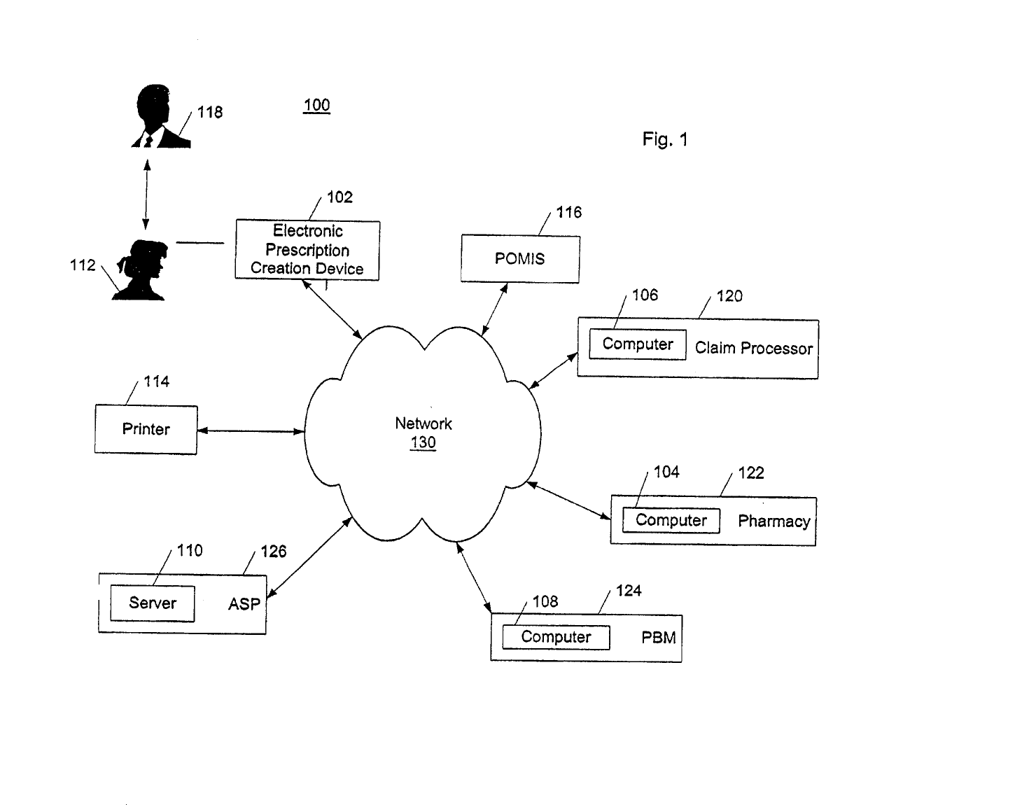

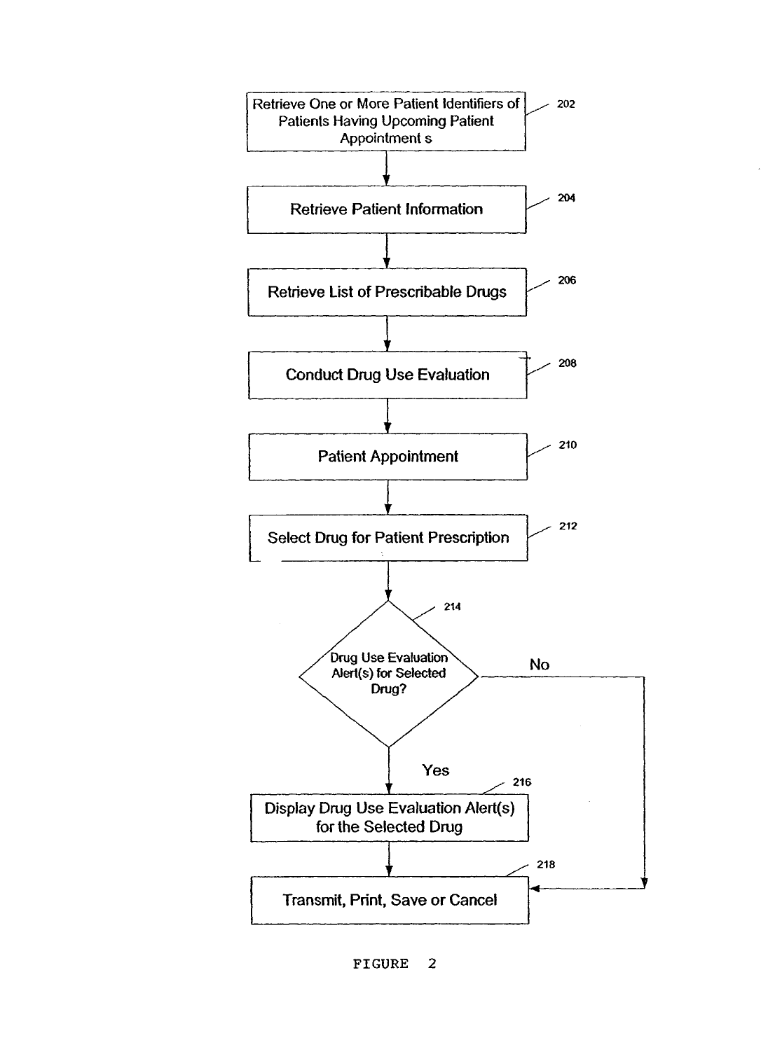

FIG. 1 illustrates one embodiment of a system 100 of the present invention, and FIG. 2 illustrates a flow chart of an exemplary method of the present invention.

As illustrated in FIG. 1, the system 100 includes an electronic prescription creation device 102, a computer 104 of a pharmacy 122, a computer 106 of a claims processor 120, a computer 108 of a pharmacy benefits management company 124 (“PBM”), a server 110 of an application service provider server 126 (“ASP”), a printer 114, a physician office management information system 116 (“POMIS”), and a network 130. As described further below, a prescriber 112 creates prescriptions for a patient 118 with the electronic prescription creation device 102, and the application service provider 126, pharmacy 122, claims processor 120, and/or pharmacy benefit management company 124 receive and communicate information over the network to facilitate the creation of prescriptions.

The network 130 may be any form of interconnecting network including an intranet, such as a local or wide area network, or an extranet, such as the World Wide Web or the Internet. The network 130 can be physically implemented on a wireless or wired network, on leased or dedicated lines, including a virtual private network (VPN). In the illustrated embodiment, the network is TCP/IP transporting data over secure sockets via user-defined ports. In another embodiment, the system 100 is internet-based and generated in accordance with web-browser and web page data, such as HTML, JavaScript, Java applets, etc. that are transmitted by the server 110 of the application service provider 126. In this alternative embodiment, browser based user interfaces are rendered on the electronic prescription creation device 102 and/or the computers 104, 106, 108 in accordance with user interface web page data that is transmitted by the server 110.

The application service provider 126 is any entity that provides software or information for the operation of the electronic prescription creation device 102, computer 104, computer 106, computer 108, and/or the physician office management information system 116. The application service provider 126 may also receive information (such as prescriptions, patient demographic information, patent prescription history information, contraindication codes, interaction codes, therapeutic class codes, prescriber schedules, etc.) from the electronic prescription creation device 102, computer 104, computer 106, computer 108, the physician office management system 116 and/or another entity via the network 130. The server 110 of the application service provider 126 is essentially a computer and may be any storage device for facilitating prescription related tasks, including a plurality of servers, a single server with multiple storage devices, or computers distributed over the network 130. Server 110 may also coexist within one or more of the computers 104, 106, 108, the electronic prescription creation device 102 and the physician office management information system 116. The physician office management information system 116 is a system that stores healthcare related information to assist in managing prescriber offices or other medical treatment facilities. Hence, the physician office management information system 116 includes a memory that stores healthcare related information, and preferably includes one or more servers, workstations, computers, or other electronic devices capable of receiving and storing healthcare related information. Healthcare related information stored by the physician office management information system 116 may be communicated to the electronic prescription creation device 102 and/or the application service provider 126 over the network 130 in any known manner, including those manners set forth below.

The pharmacy computer 104, claims processor computer 106, and pharmacy benefit management company computer 108 are connected to the server 110 via the network 130. The pharmacy computer 104, claims processor computer 106, and pharmacy benefit management company computer 108 are devices such as workstations, personal computers, laptop computers, telephones, wireless phones, personal data assistants (“PDA's”), servers, pagers, and other wireless or hardwired electronic communication devices. The computers 104, 106, 108 permit the pharmacy 122, claims processor 120, and pharmacy benefit management company 124 to carry out various aspects of processing prescriptions, including receiving and communicating information over the network 130, such as receiving electronic prescriptions and communicating the patient 118's demographic and prescription history information over the network 130.

The pharmacy 122 is any entity capable of filling prescriptions created by the electronic prescription creation device 102, such as brick & mortar pharmacies, mail-order pharmacies, internet pharmacies, wholesale pharmacies, and other entities who sell prescription drugs, i.e., any prescribed over-the-counter drug or any prescribed medications that can only be sold by a pharmacy or dispensed after an order by an appropriately licensed prescriber. Although one pharmacy 122 is illustrated in FIG. 1, the system 100 may include any number of pharmacies.

The claims processor 120 and the pharmacy benefits management company 124 are entities that adjudicate claims for health insurers. That is, the claims processor 120 and the pharmacy benefit management company 124 contract with health insurance providers such that the pharmacy 122 submits bills for prescriptions to the claims processor 120 and pharmacy benefit management company 124 rather than directly to the health insurer. The processor 120 or pharmacy benefit management company 124 essentially advises the pharmacy 122 if the patient 118's health insurance provider will pay for the prescription such that the pharmacy is assured that it will be paid from the health plan when the pharmacist submits the bill for the prescription to the claims processor or pharmacy benefit management company.

As described below in further detail, the prescriber 112 will create one or more paper or electronic prescriptions for the patient 118 with the electronic prescription creation device 102. The electronic prescription creation device 102 is a device by which the prescriber 112 can view information about the patient 118 and create an electronic or paper prescription for the patient 118, preferably at the point-of-patient-care (the location where the patient 118 is being diagnosed). The electronic prescription creation device 102 includes a user input/output, which may include a memory and a display for rendering a graphical user interface, and is configured to run software to view information about the patient 118 and to create prescriptions as described below. The electronic prescription creation device 102 is connected to the server 110 via the network 130, and may, via the network 130, retrieve and transfer information (such as software for carrying out prescription creation activities, as well as other information, such as the prescriber's 112 upcoming patient schedule, patient medical history information, patient prescription history information, diagnosis information, drug lists, drug use evaluation alerts, etc.) from and to a memory located at the server 110, one or more of the computers 104, 106, 108, the physician office management system 116, and/or some other location, such as a health maintenance organization (“HMO”).

Suitable implementations of the electronic prescription creation device 102 include devices such as personal computers, workstations, laptop computers, wired or wireless telephones, portable workstations, personal digital assistants (“PDA's”), pagers, and various other electronic devices capable of creating prescriptions. U.S. Pat. Nos. 5,884,273, 5,737,539 and 5,561,446, the entire disclosures of which are hereby incorporated by reference, describe the structure and operation of suitable electronic prescription creation devices. In a preferred embodiment, the electronic prescription creation device 102 is a PDA running Windows CE and is programmed by the application service provider 126.

Alternative embodiments of the system 100 may include more or less of the components illustrated in FIG. 1. For example, the system 100 may only include the network 130, the server 110, the pharmacy benefit management company 124, and the electronic prescription device 102, which may also be connected to a stand-alone printer to print paper prescriptions. Additionally, the system 100 may include any number of electronic prescription creation devices 102 for use by different prescribers, and any number of different pharmacies 122, claim processors 120, and pharmacy benefit management companies 124.

The operation of one embodiment of the system 100 is now described with reference to FIG. 2. FIG. 2 illustrates a schematic of a method of creating a prescription with the electronic prescription creation device 102 in accordance with one embodiment of the present invention. As described below, the orders of the steps illustrated in FIG. 2 can vary and still be within the confines of the present invention. In addition, it is also contemplated that one or more of the steps illustrated in FIG. 2 may be omitted or combined and still fall within the confines of embodiments of the present invention.

As described further below, the electronic prescription creation device 102 allows the prescriber 112 to create and view the contents of a prescription via selecting and inputting information through an interactive display, keys, a voice recognition device, or other input mechanism. In a step 202, the process begins when the application service provider 126 or another entity retrieves one or more patient identifiers of patients that have upcoming appointments with the prescriber 112. Upcoming patient appointments are patient appointment times that have not occurred at the time they are retrieved. A retrieved patient identifier may include, but is not limited to, a patient name, a patient social security number, a patient password, a patient health insurance plan identifier, a patient pharmacy benefit identifier, a patient e-mail address, a universal patient identifier, or any other identifier or combination of identifiers distinguishing one particular patient from other patients. Patient identifiers also include a patient's age and gender. For example, the patient 118 may have an appointment with the prescriber 112 within a day or two. The application service provider 126 retrieves identifiers of the patient 118, such as the patient 118's health identification number, age, and gender prior to the patient 118's appointment with the prescriber 112.

The patient identifiers of patients that have upcoming appointments with the prescriber 112 may be retrieved from the physician office management information system 116 and/or the electronic prescription creation device 102, which preferably both contain the prescriber 112's upcoming schedule. In one embodiment, the electronic prescription creation device 102 imports the prescriber 112's upcoming schedule from the physician office management information system 116 by emulating a terminal of the physician office management information system 116 and scraping the patient identifiers from desired data fields, such as in the manners described in U.S. patent application Ser. No. 09/635,876, filed Aug. 10, 2000, the entire disclosure of which is hereby incorporated by reference. The application service provider 126 then accesses a memory of the electronic prescription creation device 102 to retrieve the patient identifiers of patients that have upcoming appointments with the prescriber 112. In a further embodiment, the application service provider 126 retrieves the patient identifiers of patients that have upcoming appointments with the prescriber 112 directly from the physician office management information system 116 by emulating a terminal of the physician office management system 116 and scraping the patient identifiers. In another embodiment, the physician office management information system 116 and/or the electronic prescription creation device 102 are designed to exchange information with the application service provider 126 or another entity such that the application service provider 126 or another entity may query the electronic prescription creation device 102 or the physician office management information system 116 for the patient identifiers of patients that have upcoming appointments with the prescriber 112. In response to the query, the electronic prescription creation device 102 and/or the physician office management information system 116 will communicate the patient identifiers of patients that have upcoming appointments with the prescriber 112 via the network 130. In an alternative embodiment, the application service provider 126 and the electronic prescription creation device 102 utilize a local or remote shared memory, such that the application service provider will directly access a database of the electronic prescription creation device 102 to retrieve data from predetermined data fields known to contain the patient identifiers of patients that have upcoming appointments with the prescriber 112.

Based on the retrieved patient identifiers, the application service provider 126 identifies those patients that have upcoming appointments with the prescriber 112. After the application service provider 126 retrieves the patient identifiers of patients that have upcoming appointments with the prescriber 112, the application service provider, at a step 204, retrieves historical patient information, preferably for each of the identified patients identified to have an upcoming patient appointment time with the prescriber 112. The retrieved historical patient information may include patient prescription history information or patient medical history information, but preferably includes the patient prescription history information and the patient medical history information. The patient medical history information of a specific patient is essentially information regarding the patient's medical past and may include any one of or combinations of the following information: a disease of the patient; a condition of the patient; an allergy of the patient; a diet of the patient; a pregnancy status of the patient; and a lactation status of the patient. The patient prescription history information of a specific patient is essentially information regarding prescriptions previously prescribed to the patient and may include any one of or combinations of the following: a drug identifier of one or more previously prescribed drugs; a quantity of one or more previously prescribed drugs; a days supply of one or more previously prescribed drugs; and other information regarding previously prescribed drugs. The patient medical history information and the patient prescription history information may be retrieved from the claim processor 120, the pharmacy 122, the PBM 124, the electronic prescription creation device 102, the physician office management information system 116, the application service provider 126, or another entity.

In one embodiment, a portion of the historical patient information is retrieved from the claim processor 122 or PBM 124 and includes a drug identifier (such as a NDC code) of one or more previously prescribed drugs, a quantity of one or more previously prescribed drugs, and a days supply of one or more previously prescribed drugs. A portion of the historical patient information is also retrieved from the electronic prescription creation device 102, the application service provider 126, and/or the POMIS 116 and includes: a disease of the patient; a condition of the patient; an allergy of the patient; a diet of the patient; a pregnancy status of the patient; and a lactation status of the patient. As will be appreciated, the application service provider 112 or another entity may retrieve prescription history information beforehand or simultaneously with the retrieved patient identifier of the patients that have upcoming patient appointments with the prescriber 112. The historical patient information may be retrieved in any variety of manners, such as through one or more queries, via a shared memory, or other suitable implementation.

As is also illustrated in FIG. 2, the application service provider 126 or another entity, at a step 206, retrieves a list of drugs that may be prescribed with the electronic prescription device 102. The list of drugs may include all of the possible drugs that may be prescribed with the electronic prescription creation device 102, or may be a subset of all the possible drugs that may be prescribed with the electronic prescription creation device. For example, the retrieved list of drugs may be a list of drugs that are most frequently prescribed by the prescriber 112 with the electronic prescription creation device 102. Drugs that are prescribed by the prescriber 112 a predetermined frequency may qualify for the list of most frequently prescribed drugs. For example, in one embodiment, only drugs that are prescribed 50% more often than other prescribable drugs qualify for the most frequently prescribed drug list. Alternatively, the electronic prescription creation device 102 and/or the application service provider 126 may track the number of times a drug is prescribed by the prescriber 112 and only include the top 20, 50, 100, or 200 most frequently prescribed drugs in the most frequently prescribed drug list. In yet a further embodiment, the list of drugs to be retrieved may be a subset of all the possible drugs that may be prescribed with the electronic prescription creation device, where the application service provider 125, the pharmacy 122, the PBM 124, the claim processor 120, the prescriber 112, or some other entity selects those drugs that qualify for the subset.

In a further embodiment, the retrieved subset of drugs for the drug use evaluation may be determined for each specific patient based on a preliminary condition or diagnosis of the patient. For example, the patient 118 may have indicated that he or she had chest pains prior to the appointment with the prescriber 112, and a component of the system 100 may determine a category of drugs that are most likely to be prescribed based on the patient's indicated preliminary condition. Hence, the subset of drugs may be selected drugs within predetermined therapeutic classes.

The list of prescribable drugs may be retrieved from the electronic prescription creation device 102, the application service provider 126, the claim processor 120, the pharmacy 122, the PBM 124, or some other entity, such as a health maintenance organization. As indicated in FIG. 2, the list of prescribable drugs is retrieved before the patient 118 is diagnosed by the prescriber 112 at the patient's appointment and before the prescriber has selected a drug for a prescription for the patient.

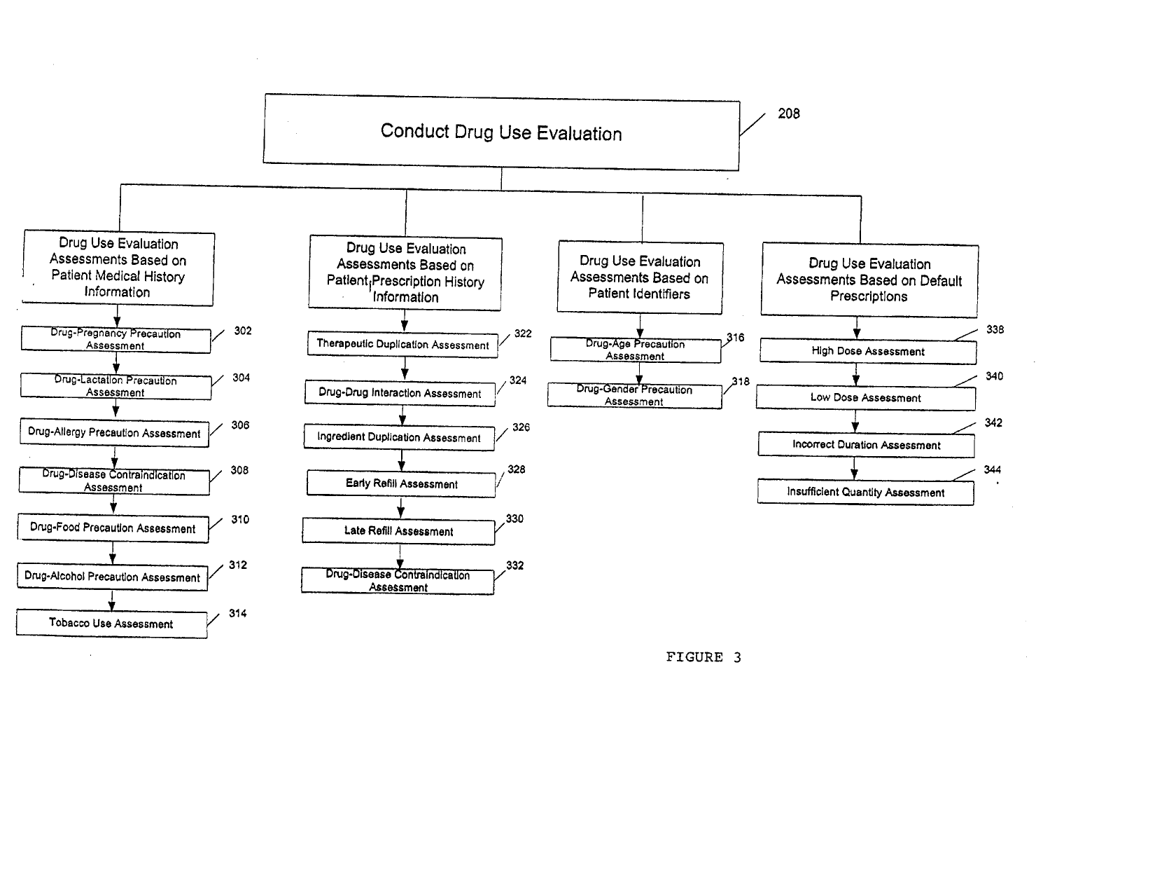

After the patient identifiers, historical patient information, and list of prescribable drugs are retrieved, at a step 208, drug use evaluation is conducted, preferably for each of the drugs in the previously retrieved list of prescribed drugs and for each patient identified by the previously retrieved patient identifiers of patients that have upcoming patient appointment times with the prescriber 112. Drug use evaluation (“DUE”) is one or more assessments designed to promote appropriate and effective use of drugs by warning prescribers that potentially harmful events may occur if a specific drug is prescribed. In the illustrated embodiment, the conducted drug use evaluation searches for standard complications, indications, precautions, and other alerts that are typically searched for by pharmacies, claim processors, and pharmacy benefit management companies. The application service provider 126 or another entity conducts the drug use evaluation by carrying out drug use evaluation assessment routines, such as those commercially available from software providers. The drug use evaluation assessments generally fall into four categories: those that are based on the prescription history information of the patient; those that are based on the medical history information of the patient; those that are based on default prescription information; and those that are based on patient identifiers, such as age and gender. Examples of drug use evaluation assessments that are based on patient prescription history information include: therapeutic duplication assessments; ingredient duplication assessments; drug-drug interaction assessments; drug-disease contraindication assessments; and early and late refill assessments. Examples of drug use evaluation assessments that are based on the patient medical history information include: drug-pregnancy precaution assessments; drug-lactation precaution assessment; drug-allergy precaution assessments; drug-disease contraindication assessments; drug-food precaution assessments; drug-alcohol precaution assessments; and tobacco use assessments. Examples of drug use evaluation assessments that are based on patient identifiers include drug-age precaution assessments and drug-gender precaution assessments. Examples of drug use evaluation assessments that are based on default prescription information include: high dose assessments; low dose assessments; incorrect duration assessments; and insufficient quantity assessments. FIG. 3 illustrates one example of drug use evaluation assessments that are conducted during drug use evaluation at step 208 for each of the previously retrieved drugs and for each patient identified by the previously retrieved patient identifiers. As illustrated in FIG. 3; the drug use evaluation assessments 302, 304, 306, 308, 310, 312, 314, are each based on the patient medical history information; the drug use evaluation assessments 322, 324, 326, 328, 330, 332 are each based on the patient prescription history information; the drug use evaluation assessments 338, 340, 342, 344 that are each based on default prescription information; and the drug use evaluation assessments 316, 318 are each based on patient identifiers. A few exemplary drug use evaluation assessments are set forth below.

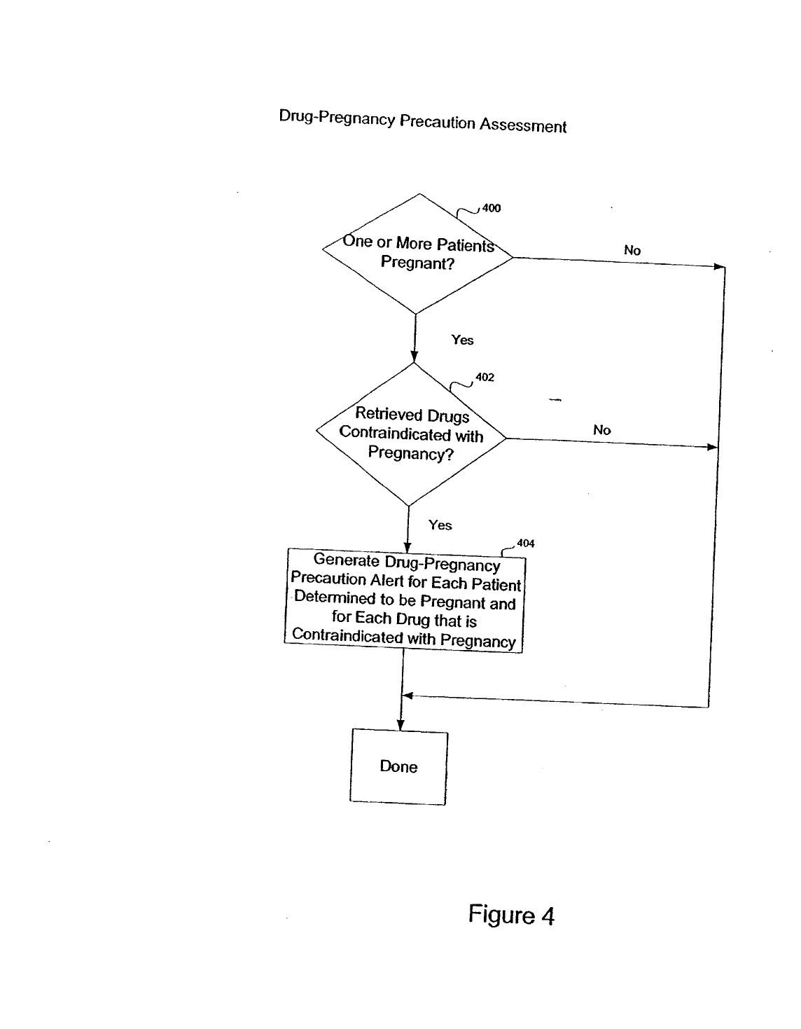

FIGS. 4-6 illustrate examples of drug use evaluation assessments that are each based on patient medical history information. FIG. 4 illustrates one example of a drug-pregnancy precautionary assessment that may be conducted in accordance with one embodiment of the present invention. As illustrated in FIG. 4, at a step 400, it is determined whether each patient identified to have an upcoming appointment with the prescriber 112 is pregnant based on the retrieved patient medical history. If one or more patients are determined to be pregnant, at a step 402, it is then determined if any of the previously retrieved drugs from the list of prescribable drugs are indicated to be contraindicated with pregnancy. Each drug that the prescriber 112 may prescribe with the electronic prescription creation device 102 has an indicator for therapeutic class, all drug interactions, and all contraindications. These indictors are commercially available and may be retrieved from an external database or another location, such as a memory of the server 110. These indicators generally correspond to the interactions, side effects, indications, contraindications, overdose, and dosage information set forth in Physician's Desk Reference, 54^{th} Edition 2000, the entire disclosure of which is hereby incorporated by reference. The electronic prescription creation device 102, the server 110, other component of the system 100, or other entity conducts a search or accesses a table to determine if an indicator or code of each drug from the retrieved drug list matches or corresponds to a drug-pregnancy contraindication indicator. If any of the retrieved drugs are indicated to be contraindicated in pregnancy then at a step 404, a drug-pregnancy precaution alert is generated for each drug that is contraindicated in pregnancy for each patient determined to be pregnant.

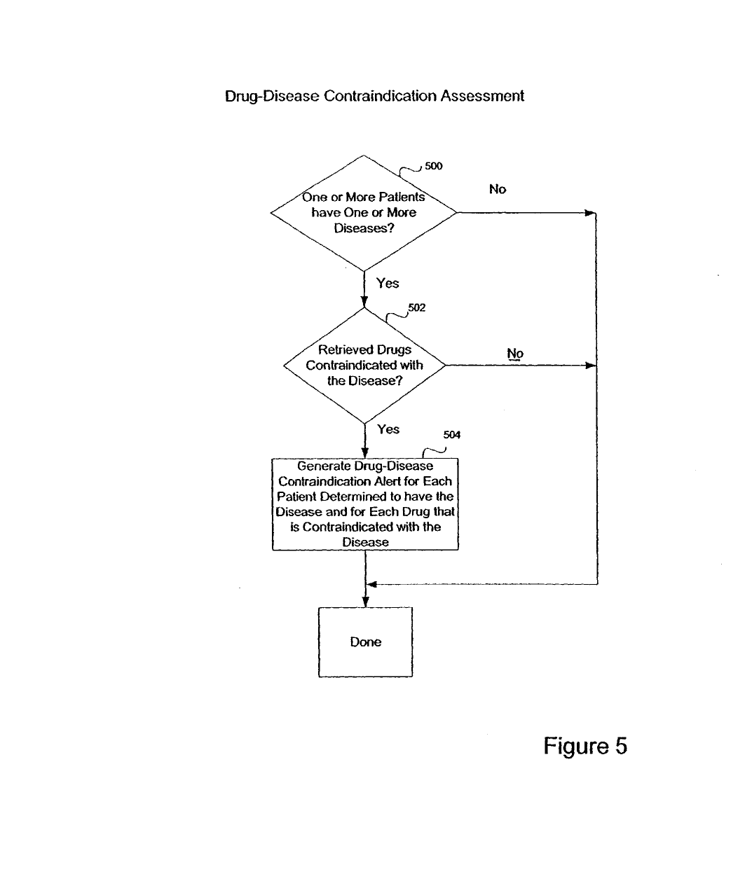

FIG. 5 illustrates one embodiment of a drug-disease contraindication assessment that may be conducted in accordance with one embodiment of the present invention. As illustrated in FIG. 5, at a step 500, it is determined whether each patient identified to have an upcoming appointment with the prescriber 112 has one or more diseases based on the previously retrieved patient medical history information. If it is determined that one or more patients have a disease, then at a step 502, it is determined whether any of the previously retrieved drugs from the list of prescribable drugs are contraindicated with the specific disease of the patient. In an alternative embodiment, it is determined whether the patient has a disease based on the patient's prescription history. For example, if the patient is currently taking insulin, then it is determined that the patient is diabetic. To determine if any of the retrieved drugs are contraindicated with a disease, it is determined if the drug-disease contraindication indicator of any of the retrieved drugs matches or corresponds to the disease's indicator. If it is determined that one or more of the previously retrieved drugs are contraindicated with the patient's disease, then at a step 504 a drug-disease contraindication alert is generated for each patient determined to have a disease and for each drug that is contraindicated with the disease.

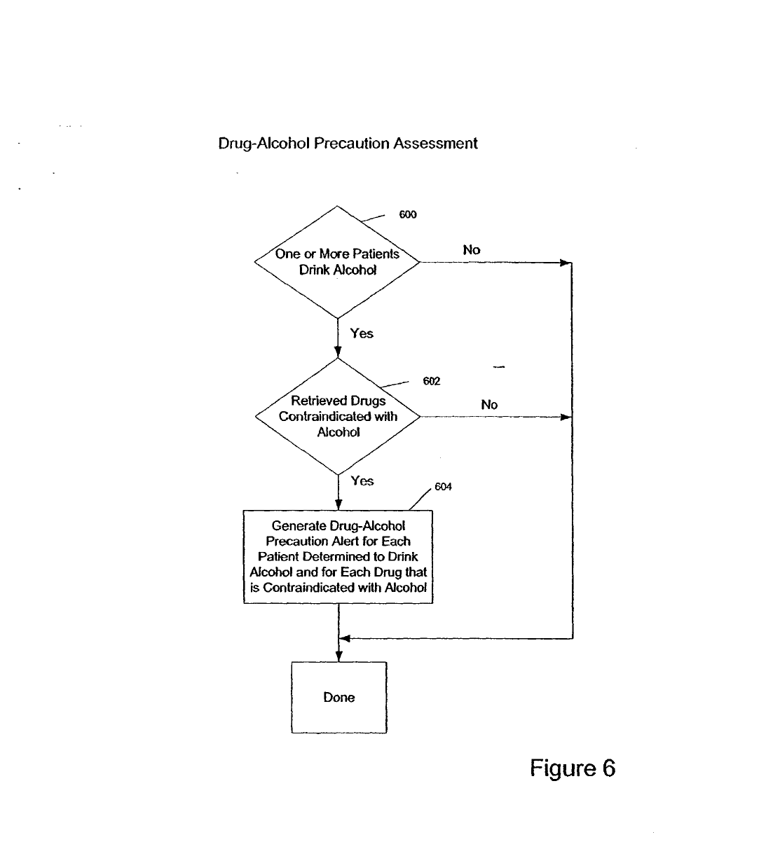

FIG. 6 illustrates one embodiment of a drug-alcohol precaution assessment. As illustrated in FIG. 6, it is first determined, at a step 600, whether each patient identified to have an upcoming appointment with the prescriber 112 or drinks alcohol based on the patient's medical history information. If it is determined that one or more of the patients drinks alcohol, it is then determined at a step 602, whether any of the previously retrieved drugs from the list of prescribable drugs is contraindicated with alcohol. To determine if any of the retrieved drugs are contraindicated with alcohol, it is determined if the indicator of any of the retrieved drugs matches or corresponds to a drug-alcohol contraindication indicator. If it is determined that any of the previously retrieved drugs are contraindicated with alcohol, then, at a step 604, a drug-alcohol precaution alert is generated for each patient determined to drink alcohol and for each drug that is determined to be contraindicated with alcohol.

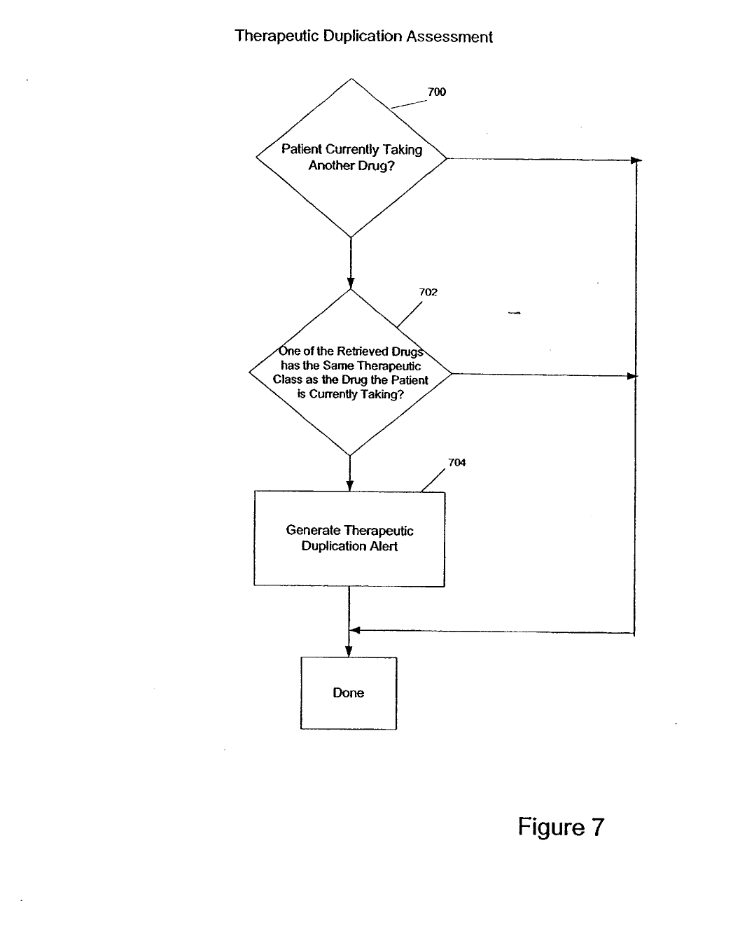

FIGS. 7-9 illustrate examples of drug use evaluation assessments that are based on the patient prescription history information. FIG. 7 illustrates one example of a therapeutic duplication assessment in accordance with one embodiment of the present invention. As illustrated in FIG. 7, at a step 700, it is first determined whether each patient identified to have an upcoming appointment with the prescriber 112 is currently taking another drug based on the patient's prescription history information. For example, it may be determined from the retrieved drug information that the patient was previously prescribed Pravacol and the previously prescribed prescription has not yet ended because the patient is still taking the prescribed Pravacol. If it is determined that one or more patients are currently taking another drug, then at a step 702, it is determined whether any of the previously retrieved drugs from the list of prescribed drugs has the same therapeutic class as the drug the patient is currently taking. To determine if any of the retrieved drugs has the same therapeutic class as the drug a patient is currently taking, it is determined if the therapeutic class indicator or code of any of the retrieved drugs matches or corresponds to the therapeutic class indicator or code of the drug the patient is currently taking. If it is determined that one of the therapeutic classes match, then at a step 704, a therapeutic duplication alert is generated for each patient determined to have possible therapeutic duplication with one or more of the retrieved drugs.

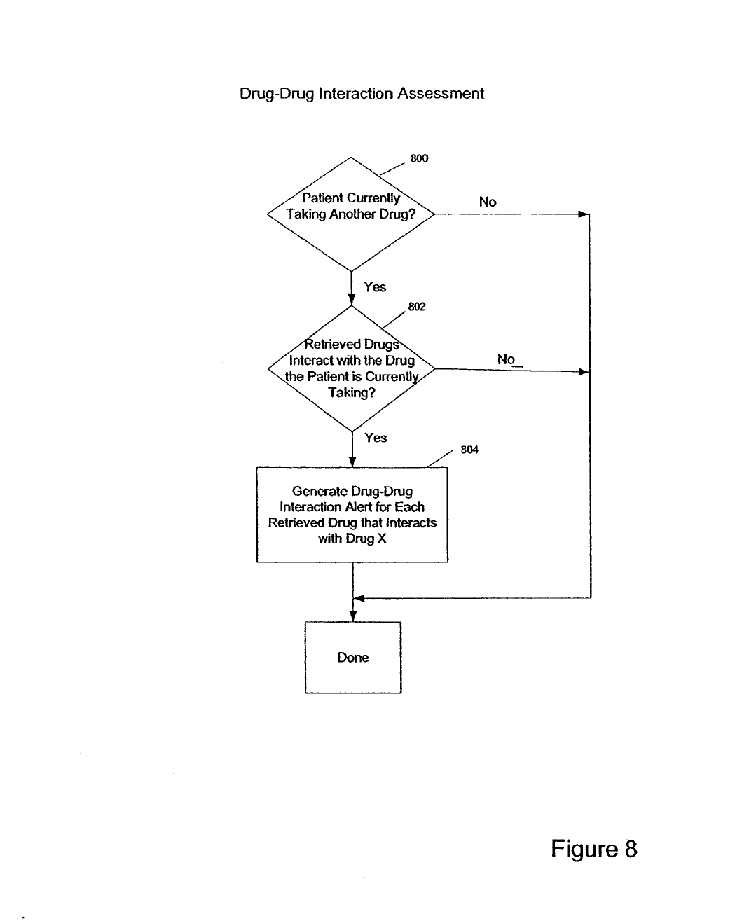

FIG. 8 illustrates one example of a drug-drug interaction assessment in accordance with one embodiment of the present invention. As illustrated in FIG. 8, at a step 800, it is first determined from the patient's prescription history information whether each patient identified to have an upcoming appointment with the prescriber is currently taking another drug. If it is determined that one or more patients are currently taking another drug, then, at a step 802, it is determined whether any of the previously retrieved drugs from the list of prescribable drugs interacts with the drug that the patient is currently taking. This is determined by comparing the drug interaction indicator or code of the drug that the patient is currently taking with the drug interaction indicator or code of any of the retrieved drugs. If the drug interaction code of the drug that the patient is currently taking matches or correspond to the drug interaction code of any of the previously retrieved drugs, then the two drugs are determined to interact and, at a step 804, a drug-drug interaction alert is generated for each retrieved drug that interacts with the drug the patient is currently taking.

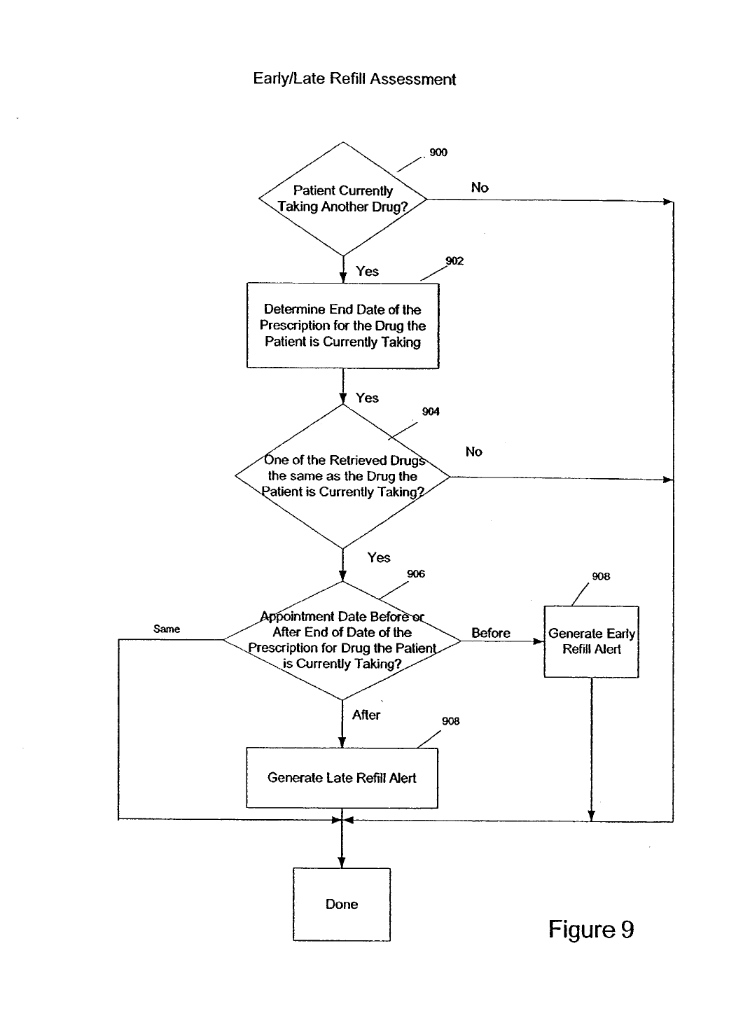

FIG. 9 illustrates one example of an early/late refill assessment in accordance with one embodiment of the present invention. As illustrated in FIG. 9, at a step 900, it is determined from the patient's prescription history information whether each patient identified to have an upcoming appointment with the prescriber is currently taking another drug. If it is determined that one or more of the patients are currently taking another drug, then at a step 902, the end date of each patient's prescription is determined based on the previously retrieved patient prescription history information. After the end date of each patient's prescription is determined, then at a step 904, it is determined whether one of the previously retrieved drugs is the same as the drug the a patient is currently taking by comparing the drug identifiers (such as NDC code) of each of the previously retrieved drugs from the list of prescribable drugs with the drug identifier of the drug the patient is currently taking. If it is determined that one of the previously retrieved drugs is the same as the drug the patient is currently taking, then at a step 906, it is determined whether the patient's appointment date with the prescriber is before or after the end date of the prescription for the drug that the patient is currently taking. If it is determined that the patient's appointment date with the prescriber is before the end date of the prescription for the drug the patient is currently taking, then at a step 908 an early refill alert is generated. However, if the patient's appointment date is after the end date of the prescription the patient is currently taking, then at a step 910, a late refill alert is generated. If the patient's appointment date is the same as the end date of the prescription the patient is currently taking, then no alert is generated.

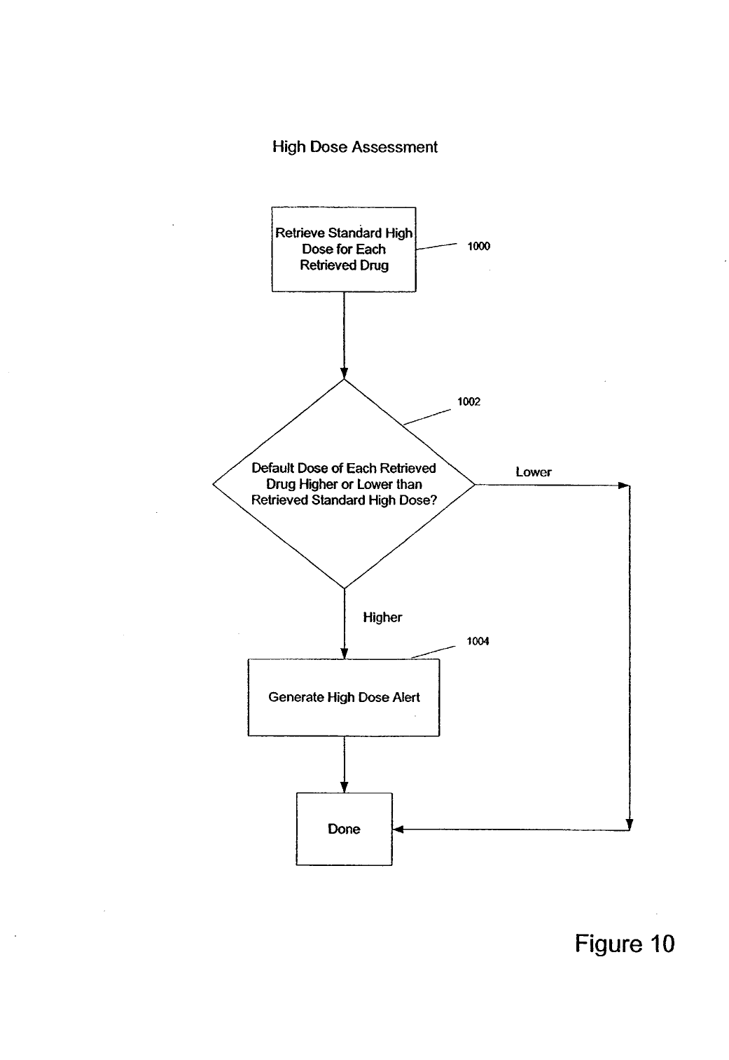

To perform drug use evaluation that does not require patient prescription history or patient medical history, the electronic prescription creation device 102, the server 110 or other component of the system 100 calculates or retrieves values based on the patient identifiers (such as weight, age, gender, etc.) and reads a memory for values representing the appropriate use of drugs for the patient. If the calculated or retrieved value is over or under the read value or if the information on the prescription is different from the read value, a drug use evaluation alert ensues. FIG. 10 illustrates one embodiment of a drug use evaluation assessment that is based on a default prescription in the electronic prescription creation device 102. As described further below, the electronic prescription creation device 102 includes a plurality of default prescription settings that the prescriber 112 may select to prescribe a drug to the patient 118. These default prescriptions settings include default dosages. As illustrated in FIG. 10, at a step 1000, the standard, i.e., recommended, high dose for each of the previously retrieved drugs from the list of prescribable drugs is retrieved from a memory of the server 110 or at another location. These standard high dosages may be based on the patient's weight, age, etc. and may be calculated for each patient, as opposed to being retrieved from a stored table. After the standard high dosages for each of the previously retrieved drugs have been retrieved, then at a step 1002, it is determined whether the default dose of each retrieved drug is higher or lower than the determined standard high dose. If it is determined that the default dose of each retrieved drug is lower than the determined standard high dose, then the drug use evaluation is complete and no high dose alert is generated. However, if it is determined at step 1002 that the default dose of any of the retrieved drugs is higher than the standard high dose, then, at a step 1004, a high dose alert is generated. For example, because the maximum recommended dose for MOTRIN is 3200 mg/day or 800 mg four times a day, if the default prescription indicates 800 mg every 4 hours (6 times a day), which would equal 4800 mg/day, a high dose drug use evaluation alert is created. As a further example, an excessive duration drug use evaluation alert will occur when antibiotics are prescribed for greater than the usual time frame, e.g., 7 or 10 days, depending on the antibiotic. The electronic prescription creation device 102, the server 110 or other component of the system 100 will read a stored table for the prescribed drug and compare the value on the table to the number of days prescribed; if the prescription value is greater than the table value, an excessive duration drug use evaluation alert is generated.

As will be appreciated, a number of other drug use evaluation assessments may be conducted that are similar to those illustrated in FIGS. 4-10 and that are similar to those conducted during post-prescription drug use evaluation commonly conducted by pharmacies, claim processors, and pharmacy benefit managers. The drug use evaluation may be conducted by the application service provider 128, the pharmacy 122, the claim processor 120, the PBM 124, the electronic prescription device 102, and/or by some other entity. As will be apparent, the drug use evaluation conducted at step 208 may include any one of or combinations of the drug use evaluation assessments illustrated in FIG. 3, as well as other drug use evaluation assessments.

Referring again to FIG. 2, after the drug use evaluation has been conducted, at a step 210, the patient 118 attends the appointment with the prescriber 112. Hence, the drug use evaluation has been conducted prior to the patient 118 attending the appointment with the prescriber 112. For example, the drug use evaluation may be conducted the evening or morning before the patient 118's appointment with the prescriber 112. When the patient 118 attends the appointment with the prescriber 112, the prescriber will diagnose the patient 118 at the point-of-care. As also illustrated in FIG. 2, the prescriber will then, at a step 212, select a drug for the patient 118's prescription.

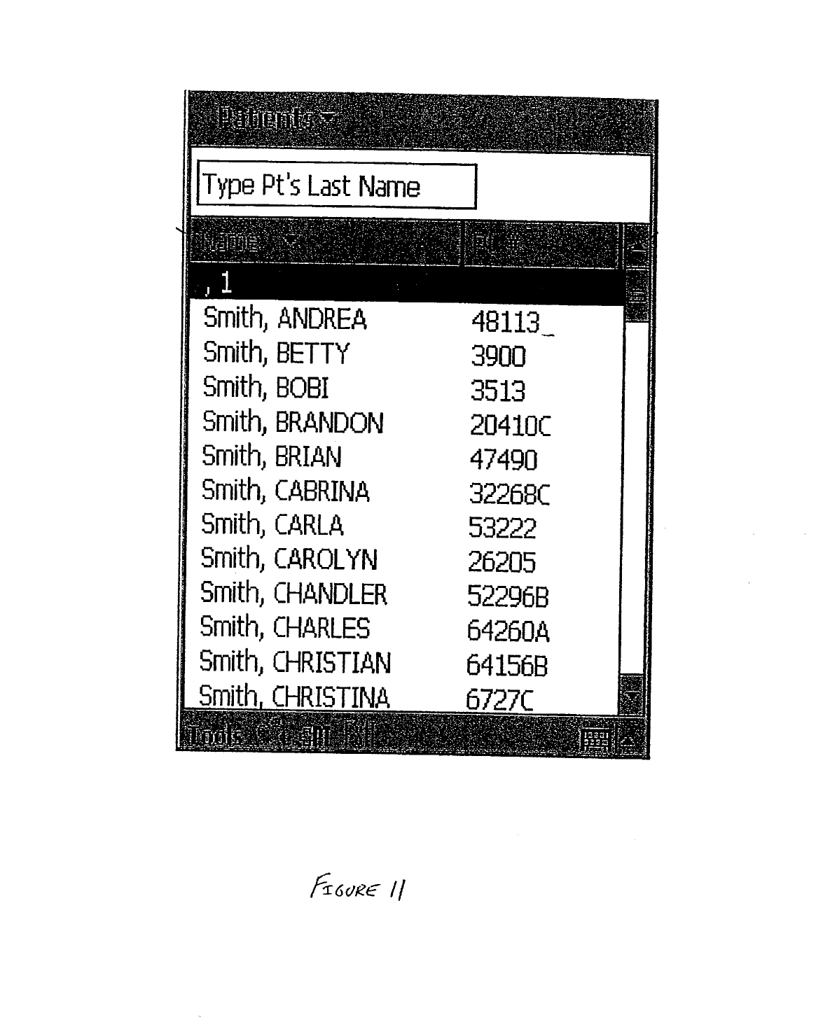

When the prescriber 112 attends the appointment with the patient 118, the prescriber 112 will select a patient identifier corresponding to the patient 118 from a patient schedule display 1300 of the electronic prescription creation device 102, as illustrated in FIG. 11. The patient schedule display 1300 includes one or more columns of patient identifiers such as patient numbers and/or patient names. Drop down windows 1302, 1304 and tool bar 1306 allow the prescriber 112 to arrange the healthcare related information in a desired format. For example, the prescriber 112 may choose to view all patients, select patients of a certain age, select patients having a certain ailment, patients to be seen during a certain time frame, etc. By selecting one of the patients listed on the patient schedule display 1300, the electronic prescription creation device 102 and/or the server 110 accesses the patient 118's healthcare related information (including prior prescription or medical history of the patient) previously or concurrently retrieved from the physician office management information system 116 or another entity.

After the electronic prescription creation device 102 has retrieved the healthcare related information for the selected patient, the prescriber 112 creates a prescription for the patient 118 by specifying the constituents of the prescription. In the illustrated embodiment, the prescriber 112 first specifies a drug for the prescription. This can be achieved by any one of three options for selecting a drug.

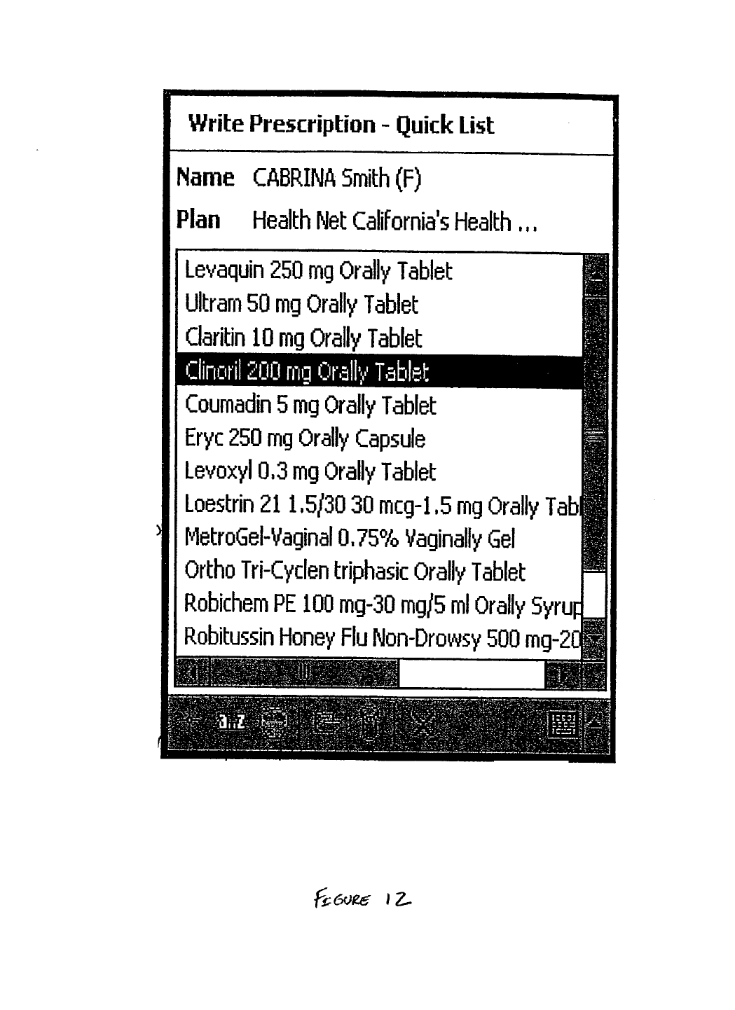

The first option for selecting a drug is a quick list option, to which the electronic prescription device 102 defaults unless instructed otherwise. FIG. 12 illustrates a quick list display 1400 of the electronic prescription creation device 102, which includes a list of drugs with default dosages and formulations most frequently prescribed by the prescriber 112. For example, FIG. 12 illustrates an example in which the prescriber has selected the drug “Clinoril 200 mg Orally Tablet” from the prescriber's personal quick list of most frequently prescribed drugs. The prescriber 112 may select any of the displayed quick list drugs included in the quick list display 1400. As further illustrated in FIG. 12, the display 1400 also includes a tool bar 1402 displaying a number of icons 1404, 1406, 1408.

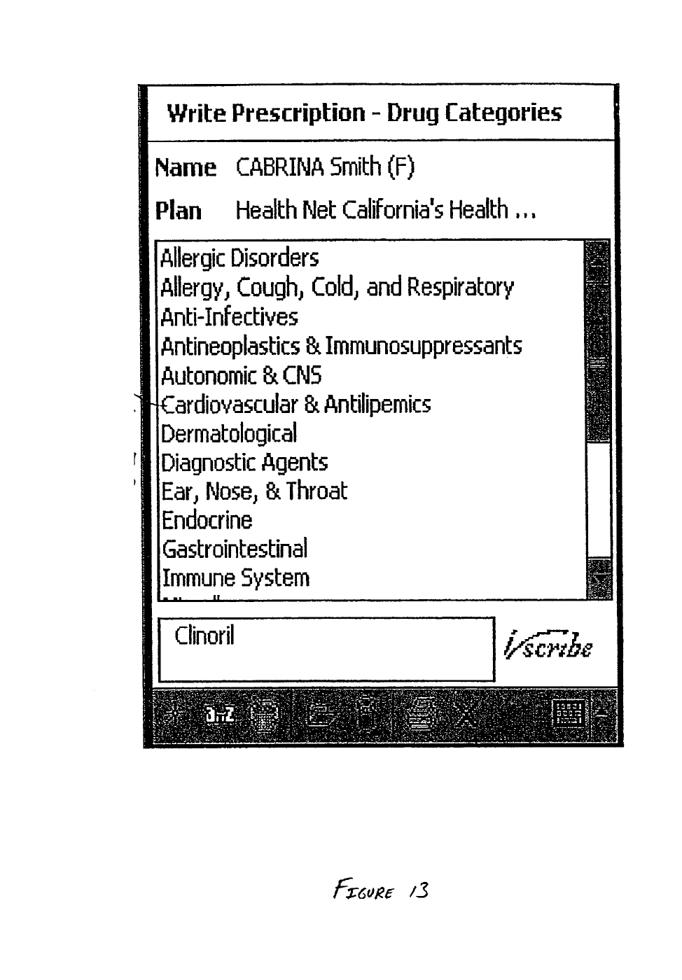

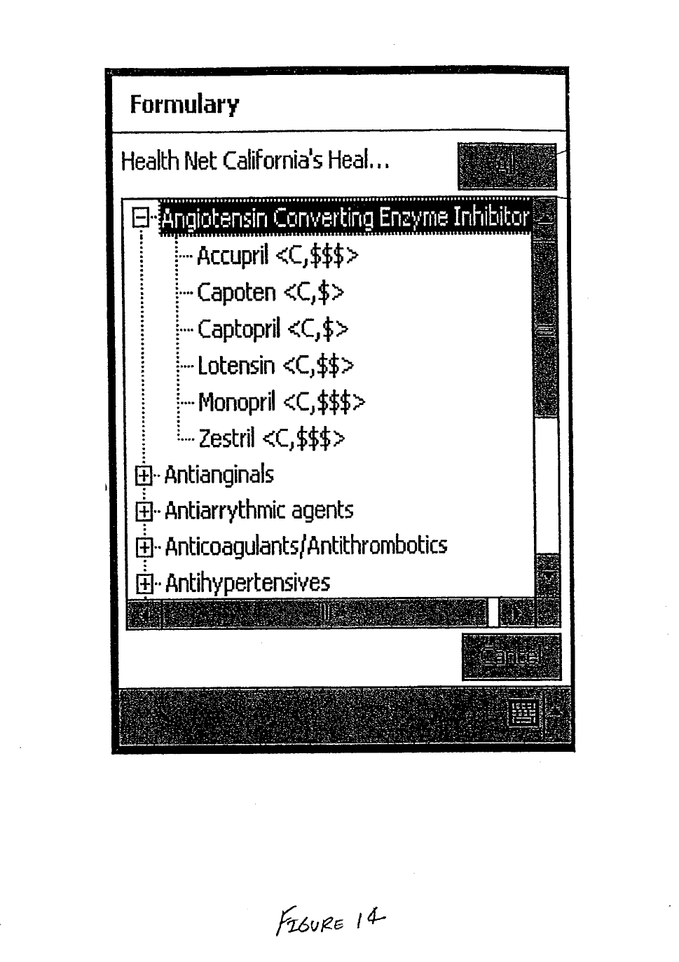

If the prescriber does not desire to prescribe a drug listed on the quick list display 1400, the prescriber may select the mortar and pestle icon 1408, which will cause the electronic prescription creation device 102 to display a therapeutic category drug selection display 1500 illustrated in FIG. 13. The therapeutic category display 1500 lists alphabetically arranged therapeutic categories, such as those illustrated in FIG. 13. The therapeutic category display 1500 helps the prescriber 112 find a drug to treat a diagnosed condition of the patient 118. For example, if the prescriber 112 determines that the patient needs a drug that is generally prescribed to treat a cardiovascular and antilipemic condition, the prescriber 112 will select the “Cardiovascular & Antilipemics” icon 1502 illustrated in FIG. 13. Selecting the “Cardiovascular & Antilipemics” icon 1502 will cause the electronic prescription creation device 102 to display the therapeutic subcategory display 1600 illustrated in FIG. 14. The therapeutic subcategory display 1600 will list subcategories of drugs within the therapeutic category selected by the prescriber 112 at the therapeutic category display 1500. For example, because the prescriber 112 has selected the “Cardiovascular & Antilipemics” icon 1502, the subcategory display 1600 will display icons of subcategories of drugs that fall within the general therapeutic class of cardiovascular and antilipemics, such as the “Angiotensin Converting Enzyme Inhibitor” subcategory icon 1602 and the “Antianginals” subcategory icon 1608 illustrated in FIG. 14. If the prescriber 112 selects one of the subcategories displayed on the therapeutic sub category display 1600, one or more drugs within the selected subcategory will be presented by the electronic prescription creation device 102. In the illustrated embodiment, the prescriber 112 has selected the “Angiotensin Converting Enzyme Inhibitor” subcategory icon 1602, which caused the electronic prescription creation device 102 to display a list of drugs 1606 (Accupril, Capoten, Captopril, Lotensin, Monopril, Zestril) within the subcategory 1602.

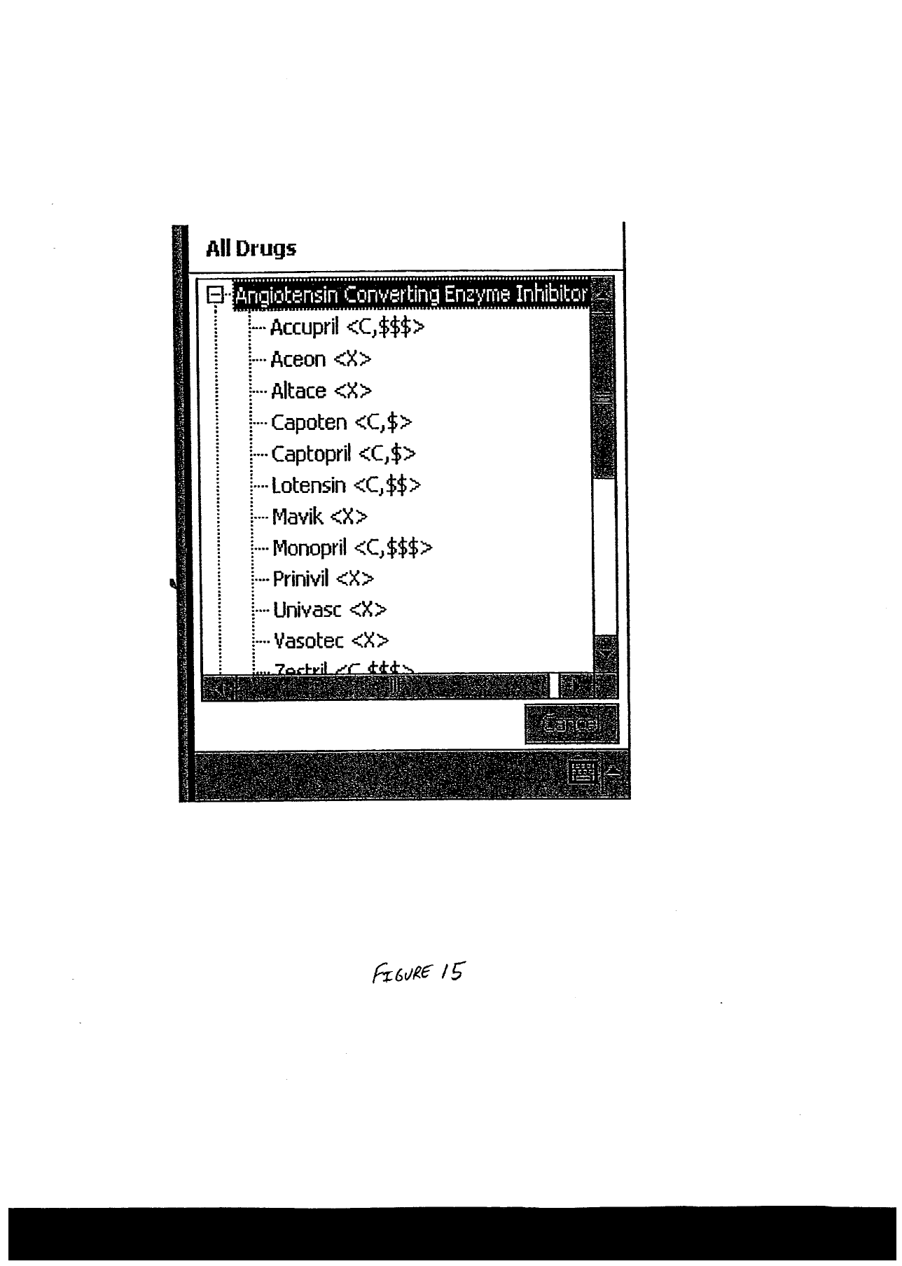

As illustrated in FIG. 14, each of the drugs listed within the subcategory 1602 is adjacent a “C” icon as well as one or more dollar sign (“$”) icons. The “C” icon represents that the list of drugs within the subcategory are all covered by the patient 118's health insurance plan. The “$” icon is a representation of the relative cost of each drug with respect to each other. In the illustrated embodiment, the electronic prescription creation device will recognize the patient 118's health care insurance plan and only display those drugs in the therapeutic subcategory that are covered by the patient's health insurance plan. “Covered” or “formulary” drugs refers to those drugs that the patient's health insurance provider will pay some or all of the cost for under a patient's health insurance plan. Drugs that the patient's health insurance plan will not pay for are generally referred to as “non-formulary” drugs or drugs that are not “covered.” If the prescriber 112 desires to view all the drugs within the specific sub-category 1602, the prescriber will select the “all” icon 1604, which will cause the electronic prescription creation device to display both formulary and non-formulary drugs within the specific subcategory 1602, as illustrated by the formulary and non-formulary subcategory display 1700 illustrated in FIG. 15.

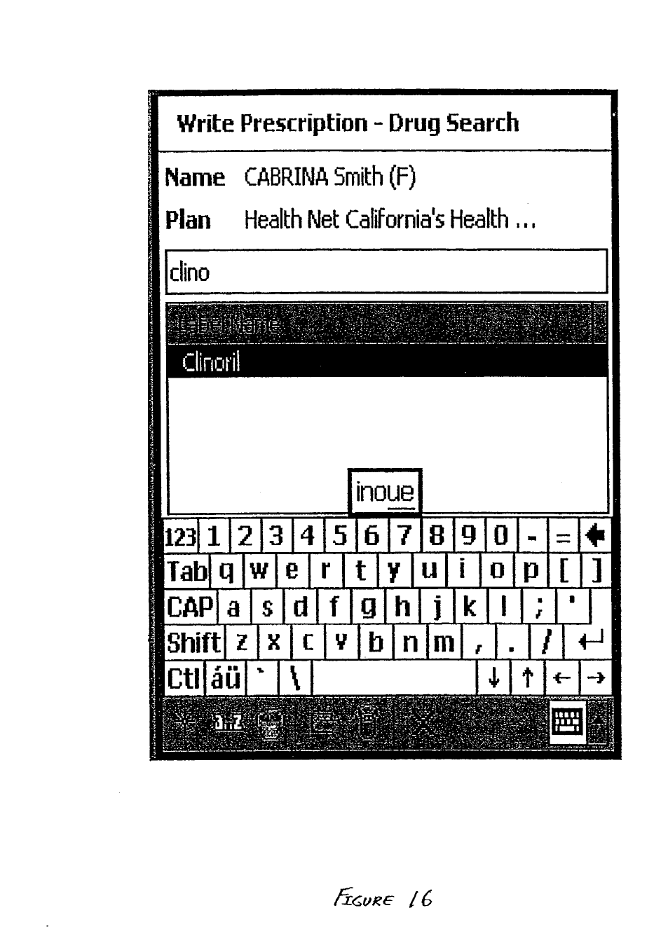

Referring again to FIG. 12, if the prescriber 112 decides not use choose a drug via the quick list option or the therapeutic class option, the prescriber may choose an A-Z drug selection option by selecting the A . . . Z icon 1406. When the prescriber selects the A-Z option, the electronic prescription creation device 102 will display the alphabetic drug selection display 1800 illustrated in FIG. 16. The alphabetic drug selection display 1800 is essentially a feature by which the prescriber can search for a specific drug by name. For example, as illustrated in FIG. 16, the prescriber 112 can enter into the electronic prescription device one or more letters of the desired drug name by using the display keyboard 1802 or other entry device. If the prescriber enters the first letter of the drug, such as a “C”, the electronic prescription creation device will display all the prescribable drugs, in alphabetical order, starting with the letter “C”. If the prescriber 112 enters more than one letter, the electronic prescription creation device 102 will search for drugs having the entered order of letters. In the illustrated example, the prescriber has entered “clino”; the electronic prescription creation device 102 searches for a drug with this combination of letters and displays the drug “Clinoril” for selection by the prescriber.

As described above, the prescriber can utilize three display options to select a drug for prescribing: the quick list display 1400, the therapeutic category display 1500, or the alphabetic drug selection display 1800. Each of these avenues permits the prescriber 112 to select a drug for the patient 118's prescription. The prescriber 112 may select a drug displayed on the quick list display 1400, the therapeutic category display 1500, or the alphabetic drug selection display 800 by using any input device of the electronic prescription creation device 102, including a mouse, a touch screen, a wand, a keyboard, a voice recognition feature, or other input device. The selected drug may be a brand-name or generic drug, depending upon the specific drug selected by the prescriber 112. The electronic prescription creation device 102 may store a list of any number of prescribed drugs, such as those listed in the Physician's Desk Reference. Because the application service provider 126 essentially provides for the operation of the electronic prescription creation device 102, any information received by the electronic prescription creation device is considered to be received by the application service provider 126. This drug selection may also be communicated to another entity over the network 130.

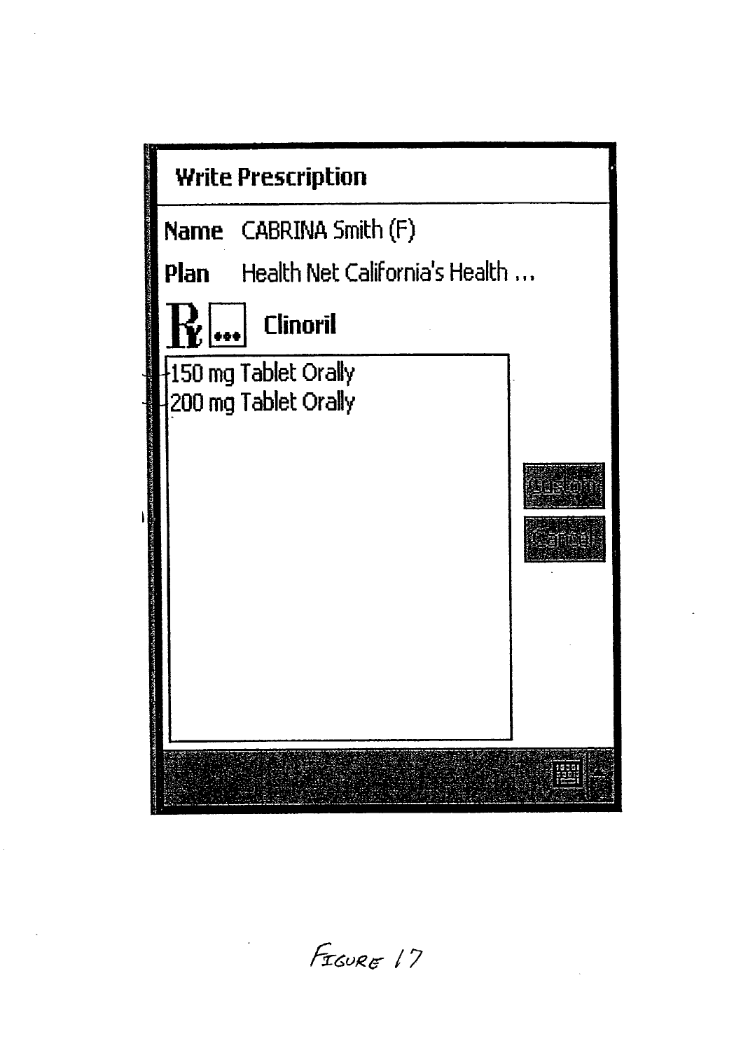

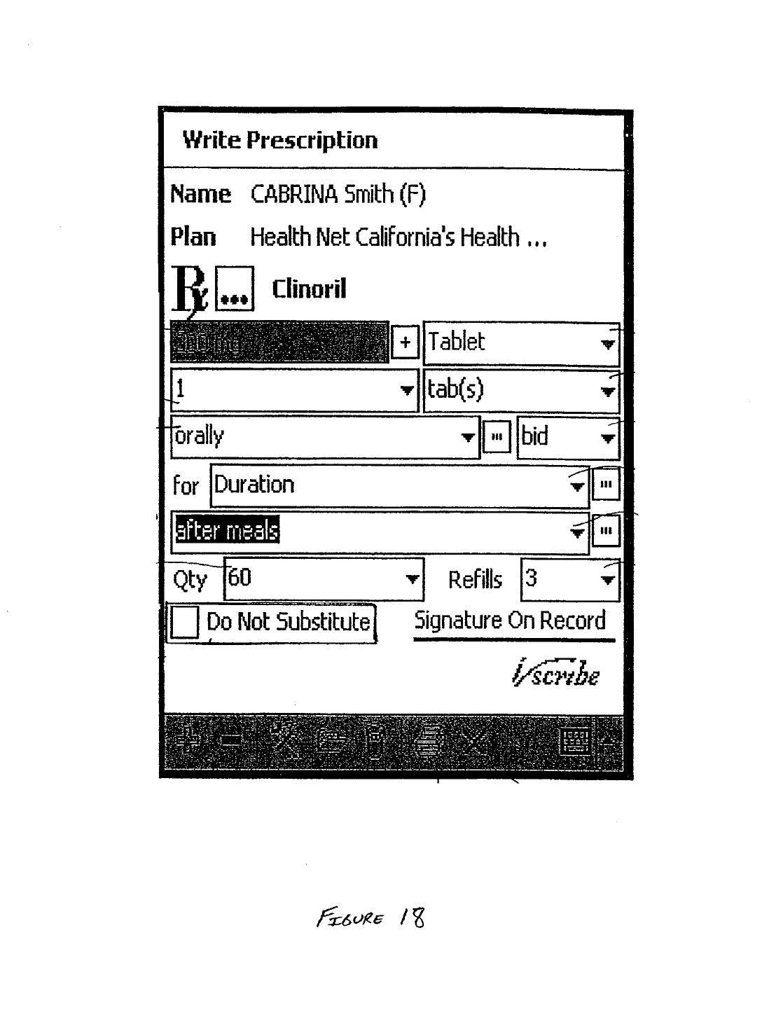

If the prescriber 112 selects a drug via therapeutic category display 1500 or via the alphabetic drug selection display 1800, the electronic prescription creation device 102 will display a strength and formulation selection display 1900 illustrated in FIG. 17. The strength and formulation display 1900 will display default strengths and formulations for the drug selected by the prescriber. For example, as illustrated by FIG. 9, if the prescriber 112 selected the drug “Clinoril” via either the therapeutic category display 1500 or via the alphabetic drug selection display 1800, the strength and formulation selection display 1900 will display one or more default strengths and formulation icons 1902, 1904 for Clinoril. In the illustrated embodiment the default strength and formulations are “150 mg Tablet Orally” and “200 mg Tablet Orally.” If the prescriber 112 selects one of the strength and formulation icons 1902, 1904, the electronic prescription creation device 102 will present the prescription creation display 2000 illustrated in FIG. 18. If the prescriber 112 selects a drug via the quick list display 1400, the electronic prescription creation device 102 will not present the strength and formulation display 1900 because the prescribers quick list of drugs already includes strengths and formulation. Hence, if the prescriber 112 selects a drug via the quick list display 1400, the electronic prescription creation device 102 will display the prescription creation display 2000, where the prescriber can alter and specify further constituents of the patent 118's prescription as described below.

As illustrated in FIG. 18, the prescription creation display 2000 includes a number of interactive icons 2002, 2004, 2006, 2008, 2012, 2014, 2016, 2018 that permit the prescriber 112 to specify and/or modify the constituents of the patient 118's prescription. The icon 2002 permits the prescriber 112 to specify the strength of the selected drug. The icon 2004 permits the prescriber 112 to specify the dosage or quantity of the selected drug. The icon 2006 permits the prescriber 112 to specify the formulation of the selected drug. The icon 2008 permits the prescriber 112 to specify the route of the selected drug. The icon 2012 permits the prescriber 112 to specify the frequency of administration of the selected drug. The icon 2014 permits the prescriber 112 to specify the duration of the selected drug. The icon 2016 permit the prescriber 112 to specify the dispense quantity of the selected drug. The icon 2018 permits the prescriber 112 to specify the permitted refills of the selected drug. The icon 2020 permits the prescriber 112 to specify any special instructions, such as “take after meals” or “as otherwise directed”. The icons 2002, 2004, 2006, 2008, 2012, 2014, 2016, 2018, 2020 may be pull down menus, text entry areas, links to other prescription creations displays, radio buttons, check boxes, or other graphical features for requesting the entry of information from the prescriber. The prescriber 112 can modify the prescription, cancel the prescription by selecting icon 1034, or finish specifying the constituents of prescription by selecting icon 1032.

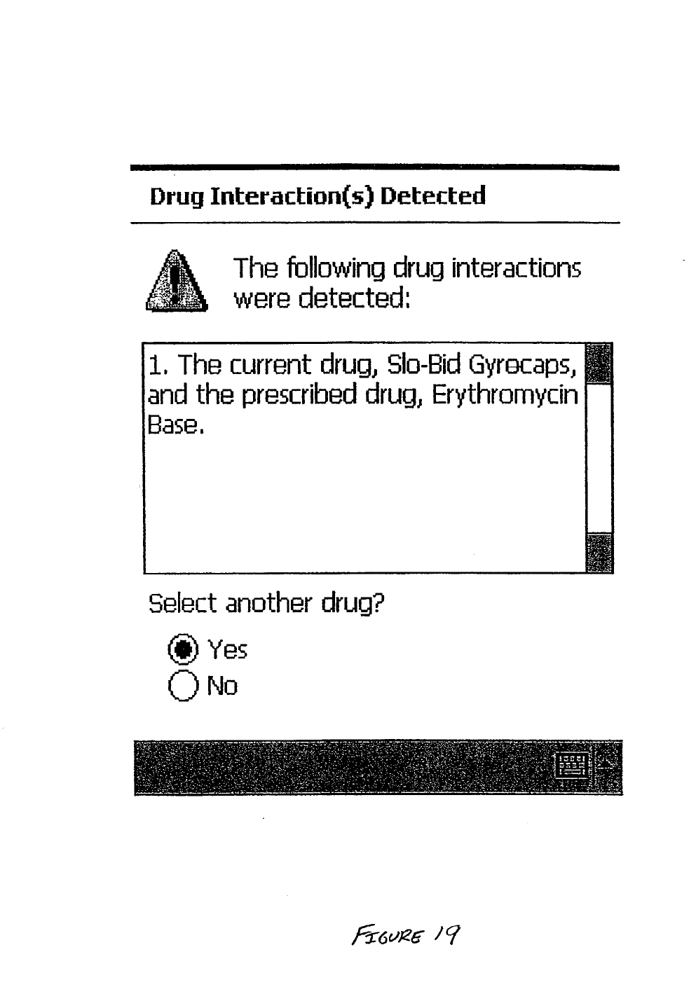

Referring again to FIG. 2, after the prescriber 112 has selected a drug for the patient 118's prescription, the electronic prescription creation device 102, the application service provider 126, the pharmacy 122, the claim processor 120, the PBM 124, and/or another entity, at a step 214, will determine if the previously conducted drug use evaluation resulted in a drug use evaluation alert for the drug selected by the prescriber 112 at step 212. Step 214 may be conducted immediately after the prescriber 112 selects a drug for the patient 118's prescription, after the prescriber finishes the prescription by selecting the icon 1032, or at some other point in time after the prescriber has selected a drug via the electronic prescription creation device 102. If it is determined that the previously conducted drug use evaluation resulted in a drug use evaluation alert for the drug selected by the prescriber 112, then, at a step 216, the electronic prescription creation device 102 will display one or more drug use evaluation alerts to the prescriber 112 via a drug use evaluation alert display 2100, such as that illustrated in FIG. 19.

The drug use evaluation alert display 1200 communicates one or more of the above-described drug use evaluation alerts to the prescriber 112. The drug use evaluation alert may be displayed to the prescriber 112 in any variety of manners and may include the specifics of the drug use evaluation alert as illustrated in FIG. 19. The displayed drug use evaluation alert may include text, icons, or other representations that communicate to the prescriber the drug use evaluation alert. Set forth below are drug use evaluation alert abbreviations that may also be used to communicate the drug use evaluation alerts to the prescriber.

DA=Drug-Allergy

DC=Drug-Disease (Inferred)

DD=Drug-Drug Interaction

DF=Drug-Food Interaction

ER=Overuse

DL=Drug-Lab Conflict

HD=High Dose

DS=Tobacco Use

ID=Ingredient Duplication

EX=Excessive Quantity

LR=Underuse

IC=Iatrogenic Condition

MX=Excessive Duration

LD=Low Dose

NR=Lactation/Nursing Interaction

MC=Drug-Disease (Reported)

OH=Alcohol Conflict

NS=Insufficient Quantity

SR=Suboptimal Regimen

PA=Drug-Age

TD=Therapeutic Duplication

PG=Drug-Pregnancy

SD=Suboptimal Drug/Indication

SF=Suboptimal Dosage Form

SX=Drug-Gender

As illustrated in FIG. 19, the drug use evaluation alert display 2100 also queries whether the prescriber would like to select another drug in view of the drug use evaluation alert. If the prescriber decides to select another drug, the electronic prescription creation device 102 will direct the prescriber 112 back to one of the displays illustrated in FIGS. 11-18, where the process of FIG. 2 resumes and the prescriber can select a different drug for the patient 118's prescription. If the prescriber eventually prescribes a drug that does not result in a drug use evaluation alert or decides to prescribe the selected drug despite a drug use evaluation alert, the electronic prescription creation device 102 presents the finish prescription screen 2200 to the prescriber 112.

As described above, in accordance with one embodiment of the present invention, the drug use evaluation may be conducted for a subset of all drugs that may be selected by the prescriber, such as only for the subset of most frequently prescribed drugs. Hence, it is possible that the prescriber 112 might select a drug for which drug use evaluation was not conducted. In this instance, the electronic prescription creation device 102 will present the prescriber 112 with a representation that communicates that the drug use evaluation was not conducted for the selected drug. This might also occur if the indications or codes for certain drugs are unavailable when conducting drug use evaluation.

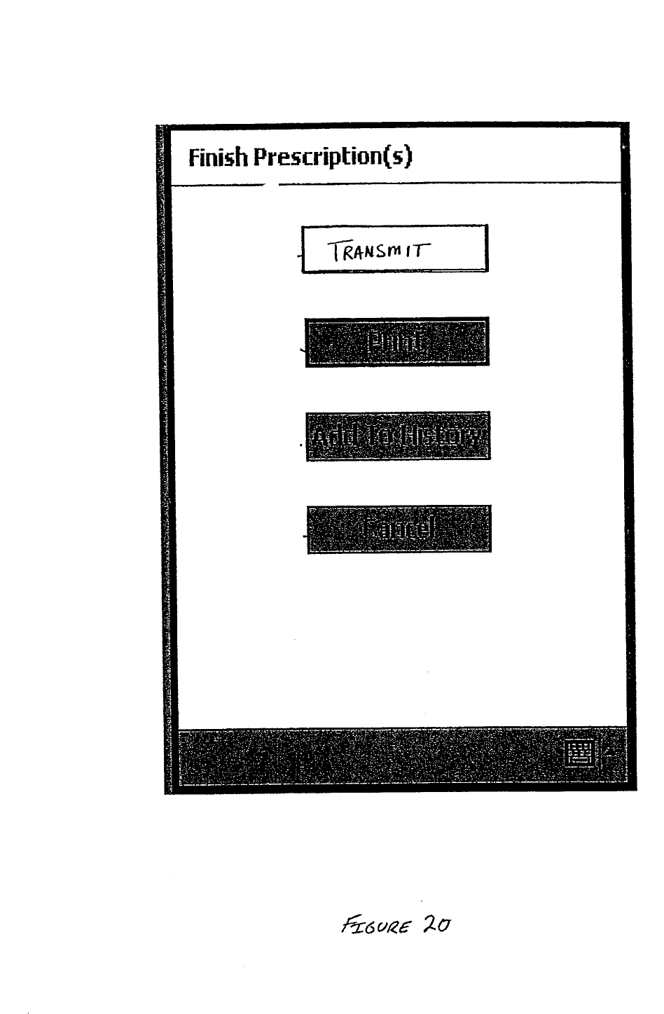

As illustrated in FIG. 20, the finish prescription screen 2200 includes a number of icons 2202, 2204, 2206 that the prescriber may select at a step 218 to complete the patient 118's prescription. If the prescriber selects the transmit icon 2202, the prescription will be transmitted over the network 130 to the pharmacy computer 104 of the pharmacy 122. If the prescriber chooses the add to history icon 2206, the patient 118's prescription will be saved in a memory for later transmission or printing. The memory that saves the patient 118's prescription may be in the electronic prescription creation device 102, the server 118, or another memory of the system 100. For example, in one embodiment, one or more created prescriptions are created and saved in the electronic prescription creation device 122, such as in an internal cache, buffer, RAM, or PC card, for later transmission, in individual or batch mode, to the server 118 and/or the computer 104 of the pharmacy 122 via the network 130. In a further embodiment, the created prescriptions are saved in a patient smart card (a personal card having a memory, such as a magnetic strip or chip) or in a patient's PDA. In one embodiment, the prescriber 112 creates a variety of different prescriptions throughout any given day with the aid of the prescription creation device 102; each of these prescriptions are temporarily saved in the prescription creation device 102 and then transmitted to the server 118 where, as described further below, they are saved for future transmission to the computer 104 of the pharmacy 122. If the prescriber 112 chooses the print icon 2204, the patient 118's prescription will be printed by the printer 114 such that the patient may immediately receive the paper prescription and bring it to the pharmacy 122 in the traditional manner. Lastly, the prescriber may select a cancel icon 2208 to cancel the prescription.

A prescription created by the electronic prescription creation device 102 may be in electronic form for direct transmission over the network 130 to the computer 104 of the pharmacy 122, or may be a paper prescription printed from a stand-alone printer or a printer 114 connected to the network 130. A prescription created by the electronic prescription creation device 102 preferably includes among its constituent of elements a patient identifier, a prescription drug identifier, and an identifier of the prescribed drug quantity. As described above, the patient identifier may include, but is not limited to, a patient name, a patient social security number, a patient password, a patient health insurance plan identifier, a patient pharmacy benefit identifier, a patient e-mail address, a universal patient identifier, or any other identifier or combination of identifiers distinguishing one particular patient from other patients.

The prescription drug identifier may include, but is not limited to, a drug name, a drug number, a drug code, or other information uniquely identifying the prescribed drug. The embodiments of the present invention apply to the prescription of drugs in general, which include any physiologically or pharmacologically active substance prescribed by a prescriber, including over-the-counter drugs. The prescribed drug may be any of the agents that are known to be delivered to humans or animals, such as medicaments, vitamins, nutrients, or the like. Drugs that may be prescribed in the context of the present invention include drugs that are prescribed to treat any variety of medical conditions. A few examples of prescribed drugs include, but are not limited to, drugs sold under the trade names Allegra, Ceftin, Celebrex, Claritin, Erythromycin, Levaquin, Prinivil, Pravachol, Viagra, Zofran, as well as generic versions of these drugs. The drug may be prescribed alone or in combination with an apparatus, such as a sustained release drug delivery system or other drug delivery apparatus.

The prescription created by the electronic prescription creation device 102 further includes an identifier of the prescribed drug quantity, which is some indication of the amount of drug that the prescriber is prescribing to the patient. While the paper and electronic prescription created by the electronic prescription creation device 102 at least includes an identifier of the patient, the prescribed drug, and the prescribed drug quantity, the prescription can include other information as well. For example, the prescription may include any of the following information:

patient name;

patient address;

prescriber name;

prescriber address;

prescriber phone number;

DEA number;

date of issuance;

prescribed drug strength;

prescribed drug dosage form (capsule, pill, etc.);

intake method or route of administration (orally, injectable, etc.);

frequency (Q6h, Q8h, monthly, etc.);

directions for use;

number of refills allowed;

permissible substitutes;

license classification;

degree classification;

license number;

diagnosis;

dispense as written indication;

reason for dispensing as written;

drug use evaluation alert;

override of a drug use evaluation alert; and

reason for overriding a drug use evaluation alert.

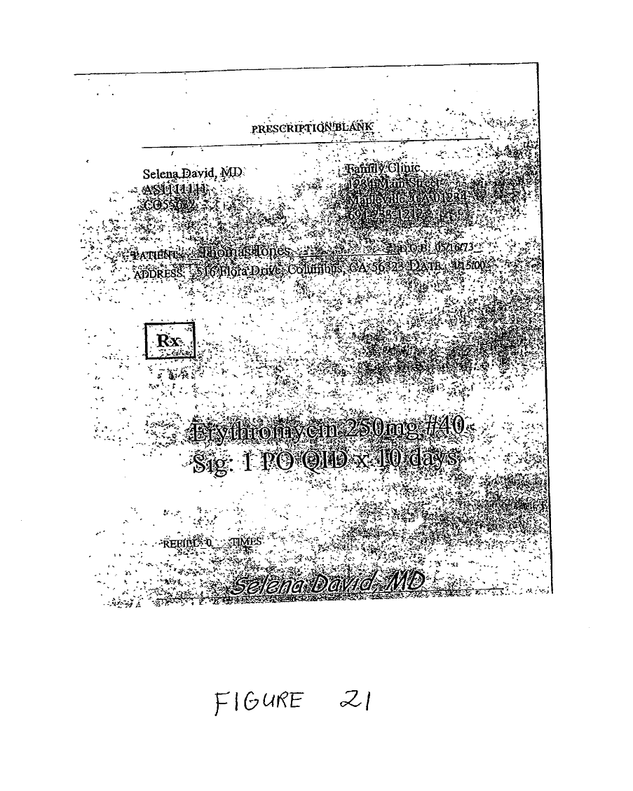

FIG. 21 illustrates one example of a paper prescription 2300 created with the electronic prescription device 102. An exemplary electronic prescription created by the electronic prescription creation device 102 may include information corresponding to that of the paper prescription 2300, as well as that of the various alternative embodiments of the paper prescriptions set forth above and below.

As will also be appreciated, the methods of the invention may include more or less of the steps illustrated in FIG. 2 and may take a different order. For example, one embodiment of the prescription creation process illustrated in FIG. 2 does not include displaying the drug use evaluation alerts. In another embodiment, the list of prescribable drugs is retrieved before the patient identifiers. In addition, the various steps illustrated in FIG. 2 may be performed by one or combinations of different entitites, such as the application service provider 126, the claim processor 120, the pharmacy 122, the pharmacy benefit manager 124, or some other entity, such as a health maintenance organization.

Because the drug use evaluation is conducted prior to the prescriber selecting the drug for the patient 118's prescription, it is not necessary for the prescriber 112 to wait for the drug use evaluation to be conducted while the prescriber create the patient's prescription. Hence, the prescriber 112 can quickly review the results (alerts) of the drug use evaluation at the point-of-care before prescribing a drug to the patient 118, which also reduces the need for the pharmacy 122, the claim processor 120, and the pharmacy benefit manager 124 to call back drug use evaluation alerts to the prescriber.

The principles, preferred embodiments, and modes of operation of the present invention have been described in the foregoing description. However, the invention that is intended to be protected is not to be construed as limited to the particular embodiments disclosed. Further, the embodiments described herein are to be regarded as illustrative rather than restrictive. Others may make variations and changes, and equivalents employed, without departing from the spirit of the present invention. Accordingly, it is expressly intended that all such variations, changes and equivalents which fall within the spirit and scope of the present invention as defined in the claims be embraced thereby.

What is claimed is:

1. A method comprising:
receiving via an electronic prescription creation device a selection of at least one drug of plurality of drugs that may be selected via the electronic prescription creation device to create a prescription for a patient;
prior to said receiving the selection, conducting a drug use evaluation for the patient to obtain at least one drug use evaluation alert, the drug use evaluation being for each of the plurality of drugs that may be selected via the electronic prescription creation device;
determining if the drug use evaluation alert corresponds to the selected one drug; and
if it is determined that the drug use evaluation alert corresponds to the selected one drug, then presenting a representation corresponding to the drug use evaluation alert on a graphical user interface of the electronic prescription creation device.

2. The method of claim 1, the plurality of drugs that may be selected via the electronic prescription creation device being a subset of a group of all drugs that may be prescribed with the electronic prescription creation device.

3. The method of claim 2, the subset being a number of drugs most frequently prescribed with the electronic prescription creation device.

4. The method of claim 1, the subset of drugs being a number of drugs specified by a prescriber or another entity.

5. The method of claim 4, the drug use evaluation alert being at least one of:
a therapeutic duplication alert;
a drug-drug interaction alert;
an ingredient duplication alert;
a drug-disease contraindication alert;
an early refill alert;
a late refill alert;
a drug-pregnancy precaution alert;
a drug-lactation precaution alert;
a drug-allergy precaution alert;
a drug-food precaution alert;
a drug-alcohol precaution alert;
an incorrect duration alert;
a high dose alert;
a low dose alert;
a tobacco use alert;
an excessive drug quantity alert;
an insufficient quantity alert;
a sub-optimal regimen alert;
a drug-age precaution alert;
a sub-optimal drug/indication alert;
a sub-optimal dosage form alert; and
a drug-gender precaution alert.

6. The method of claim 1, further comprising:
retrieving medical history information of the patient from a database, said conducting the drug use evaluation being based on at least a portion of the retrieved medical history information.

7. The method of claim 6, said conducting the drug use evaluations including:
determining if each of the plurality of drugs is contraindicated for the patient based on at least a portion of the retrieved medical history information.

8. The method of claim 6, the drug use evaluation alert being a drug-pregnancy precaution alert, the drug use evaluation including a drug-pregnancy precaution assessment comprising:
determining from the medical history information if the patient is pregnant;
determining if each of the plurality of drugs is contraindicated with pregnancy; and
if it is determined that the patient is pregnant, then generating the drug-pregnancy precaution alert for each for each drug determined to be contraindicated with pregnancy.

9. The method of claim 6, the drug use evaluation alert being a drug-disease contraindication alert, the drug use evaluation including a drug-disease contraindication assessment comprising:
determining from the medical history information if the patient has a disease;
determining if each of the plurality of drugs is contraindicated with the disease; and
generating the drug-disease contraindication alert for each drug determined to be contraindicated with the disease.

10. The method of claim 6, the drug use evaluation alert being a drug-food precaution alert, the drug use evaluation including a drug-food precaution assessment comprising:
determining from the medical history information if a diet of the patient includes a type of food;
determining if each of the plurality of drugs is contraindicated with the type of food; and
generating the drug-food precaution alert for each drug determined to be contraindicated with the food.

11. The method of claim 6, the drug use evaluation alert being a drug-alcohol precaution alert, the drug use evaluation including a drug-alcohol precaution assessment comprising:
determining from the medical history information if a diet of the patient includes alcohol;
determining if each of the plurality of drugs is contraindicated with alcohol; and
generating the drug-alcohol precaution alert for each drug determined to be contraindicated with alcohol.

12 The method of claim 6 the drug use evaluation alert being a drug-allergy precaution alert, the drug use evaluation including a drug-allergy precaution assessment comprising:
determining from the medical history information if the patient has an allergy;
determining if each of the plurality of drugs is contraindicated with the allergy; and
generating the drug-allergy precaution alert for each drug determined to be contraindicated with the allergy.

13. The method of claim 1, further comprising retrieving at least one patient identifier that includes an age of the patient, the drug use evaluation alert being a drug-age precaution alert, the drug use evaluation including a drug-age precaution assessment comprising:
determining if each of the plurality of drugs is contraindicated with the age of the patient; and
generating the drug-age precaution alert for each drug determined to be contraindicated with the age of the patient.

14. The method of claim 7, further comprising retrieving at least one patient identifier that includes a gender of the patient, the drug use evaluation alert being a drug-gender precaution alert, the drug use evaluation including a drug-gender precaution assessment comprising:
determining if each of the plurality of drugs is contraindicated with the gender of the patient; and
generating the drug-gender precaution alert for each drug determined to be contraindicated with the gender of the patient.

15. The method of claim 1, further comprising:
retrieving prescription history information of the patient from a database, said conducting the drug use evaluation being based on at least a portion of the retrieved prescription history information.

16. The method of claim 15, the drug use evaluation alert being a drug-drug interaction alert, the drug use evaluation including a drug-drug interaction assessment comprising:
determining from the prescription history information at least one drug previously prescribed to the patient;
determining if each of the plurality of drugs interacts with the least one drug previously prescribed to the patient; and
generating the drug-drug interaction alert for each drug determined to interact with the at least one drug previously prescribed to the patient.

17. The method of claim 15, the drug use evaluation alert being an ingredient duplication alert, the drug use evaluation including an ingredient duplication assessment comprising:
determining from the prescription history information at least one drug previously prescribed to the patient;
determining if at least one of the plurality of drugs is the same as the at least one drug previously prescribed to the patient; and
generating the ingredient duplication alert if it is determined that at least one of the plurality of drugs is the same as the at least one drug previously prescribed to the patient.

18. The method of claim 15, the drug use evaluation alert being at least one of an early refill alert and a late refill alert, the drug use evaluation including an ingredient duplication assessment comprising:
determining from the prescription history information an end date of at least one drug previously prescribed to the patient;
determining if at least one of the plurality of drugs is the same as the at least one drug previously prescribed to the patient;
determining if a patient appointment date is before or after the end date of the at least one drug previously prescribed to the patient;
generating the early refill alert if it is determined that the patient appointment date is before the end date of the at least one drug previously prescribed to the patient; and
generating the late refill alert if it is determined that the patient appointment date is after the end date of the at least one drug previously prescribed to the patient.

19. The method of claim I, further comprising:
retrieving information of the patient from a database, said conducting the plurality of drug use evaluations being based on at least a portion of the retrieved information.

20. The method of claim 19, the database being a claim processor's database.

21. The method of claim 19, the database being a pharmacy benefit management database.

22. The method of claim 19, the retrieved information including medical history information of the patient, the medical history information including at least one of: a disease of the patient; a condition of the patient; an allergy of the patient; a diet of the patient; a pregnancy status of the patient; and a lactation status of the patient.

23. The method of claim 19, the retrieved information including prescription history information of the patient, the prescription history information including at least one of: a drug identifier of a previously prescribed drug; a quantity of a previously prescribed drug; and a days supply of a previously prescribed drug.

24. The method of claim 1, the drug use evaluation being conducted at a computer remote from the electronic prescription creation device, further comprising:
communicating the drug use evaluation alert to the electronic prescription creation device over a network.

25. The method of claim 1, the drug use evaluation including at least one of:
a therapeutic duplication assessment;
a drug-drug interaction assessment;
an ingredient duplication assessment;
a drug-disease contraindication assessment;
an early refill assessment;
a late refill assessment;
a drug-pregnancy precaution assessment;
a drug-lactation precaution assessment;
a drug-food precaution assessment;
a drug-alcohol precaution assessment;
a high dose assessment;
a low dose assessment;
a drug-allergy precaution assessment;
a tobacco use assessment;
a drug-age precaution assessment;
a drug-gender precaution assessment;
an incorrect duration assessment; and
an insufficient quantity assessment.

26. A method comprising:
retrieving at least one patient identifier of at least one patient that has an upcoming patient appointment with a prescriber on a specific day;
prior to the appointment on the specific day, retrieving patient information from a database, the patient information being at least one of medical history information of the patient and prescription history information of the patient; and
prior to the appointment on the specific day, conducting a drug use evaluation for the patient based on the retrieved patient information.

27. The method of claim 26, further comprising:
determining if the drug use evaluation resulted in a at least one drug use evaluation alert.

28. The method of claim 27, if it is determined that the drug use evaluation resulted in the at least one drug use evaluation alert, then communicating the at least one drug use evaluation alert to an electronic prescription creation device via a network.

29. The method of claim 28, further comprising:
receiving via the electronic prescription creation device a selection of at least one drug of a plurality of drugs that may be selected via the electronic prescription creation device to create a prescription for the patient;
determining if the at least one drug use evaluation alert corresponds to the selected one drug; and
if it is determined that the at least one drug use evaluation alert corresponds to the selected one drug, then presenting a representation corresponding to the drug use evaluation alert on a graphical user interface of the electronic prescription creation device.

30. The method of claim 26, the retrieved patient information being the medical history information of the patient and the prescription history information of the patient.

31. The method of claim 26, said conducting the drug use evaluation for the patient based on the retrieved patient information including conducting drug use evaluation assessments for each drug of a plurality of drugs that may be prescribed to the patient with an electronic prescription creation device at the appointment on the specific day.

32. The method of claim 31, the plurality of drugs being a subset of all drugs that may be selected via the electronic prescription creation device.

33. The method of claim 32, the subset of drugs being a number of drugs most frequently prescribed by the prescriber with the electronic prescription creation device.

34. A method of comprising:
viewing on a graphical user interface of an electronic prescription creation device a plurality of drugs that may be selected for a prescription for a patient;
selecting via the electronic prescription creation device at least one of the plurality of drugs; and
viewing on the graphical user interface a representation corresponding to a drug use evaluation alert, the drug use evaluation alert resulting from a drug use evaluation conducted for the patient prior to said selecting the at least one of the plurality of drugs, the drug use evaluation being for at least one of the plurality of drugs that may be selected via the electronic prescription creation device.

35. The method of claim 34, further comprising:
completing the prescription with the electronic prescription creation device.

36. The method of claim 35, the prescription being a paper prescription printed with a printer in communication with the electronic prescription creation device.

37. The method of claim 35, the prescription being an electronic prescription.

38. The method of claim 34, the electronic prescription creation device being a personal digital assistant.

39. A computer-readable medium having instructions stored thereon, the instructions when executed by an electronic prescription creation device cause the electronic prescription creation device to:
create a prescription for a patient;
present on a graphical user interface of the electronic prescription creation device a plurality of drugs that may be selected for a prescription for a patient;
receive a selection of at least one of the plurality of drugs; and
present on the graphical user interface a representation corresponding to a drug use evaluation alert, the drug use evaluation alert resulting from a drug use evaluation conducted for the patient prior to said selecting the at least one of the plurality of drugs, the drug use evaluation being for at least one of the plurality of drugs that may be selected via the electronic prescription creation device.

40. A computer-readable medium having instructions stored thereon, the instructions when executed by a computer cause the computer to:
retrieve at least one patient identifier of at least one patient that has upcoming patient appointment with a prescriber on a specific day;
prior to the appointment on the specific day, retrieve patient information from a database, the patient information being at least one of medical history information of the patient and prescription history information of the patient; and
prior to the appointment on the specific day, conduct a drug use evaluation for the patient based on the retrieved patient information.

41. The computer-readable medium of claim 40, the instructions when executed by the electronic prescription creation device cause the electronic prescription creation device to:
determine if the conducted drug use evaluation resulted in at least one drug use evaluation alert.

42. A computer data signal embodied in a transmission medium comprising:
computer-readable program code for causing a computer to retrieving at least one patient identifier of at least one patient that has upcoming patient appointment with a prescriber on a specific day;
computer-readable program code for causing the computer to, prior to the appointment on the specific day, retrieve patient information from a database, the patient information being at least one of medical history information of the patient and prescription history information of the patient; and
computer-readable program code for causing the computer to, prior to the appointment on the specific day, conduct a drug use evaluation for the patient based on the retrieved patient information.

43. The computer data signal embodied in the transmission medium of claim 42, further comprising:
computer-readable program code for causing the computer to determine if the conducted drug use evaluation resulted in at least one drug use evaluation alert.

44. The computer data signal embodied in the transmission medium of claim 43, further comprising:
computer-readable program code for causing the computer to communicate the at least one drug use evaluation alert to an electronic prescription creation device separate from the computer.

45. An apparatus comprising:
a computer connectable to an electronic prescription creation device via a network, the computer including:
means for retrieving at least one patient identifier of at least one patient that has an upcoming appointment with a prescriber on a specific day;
means for retrieving, prior to the appointment on the specific day, patient information from a database, the patient information being at least one of medical history information of the patient and prescription history information of the patient; and
means for conducting, prior to the appointment on the specific day, a drug use evaluation for the patient based on the retrieved patient information.

46. A method comprising:
conducting a drug use evaluation for a specific patient, said conducting the drug use evaluation being prior to a prescriber selecting a drug for a prescription for the specific patient with a hand-held electronic prescription creation device at a point-of-patient-care, the drug use evaluation being for at least one of a plurality of drugs that may be prescribed to the patient with the hand-held electronic prescription creation device.

47. A method comprising:
conducting a drug use evaluation for a specific patient prior to the patient arriving for an appointment with a prescriber, the drug use evaluation being for each of a plurality of drugs that may be prescribed to the specific patient with a hand-held electronic prescription creation device, the plurality of drugs being a subset of a group of all drugs that may be viewed on a graphical user interface of the hand-held electronic prescription creation device and selected for a prescription for the patient.
